(19) United States
(12) Patent Application Publication
(10) Pub. No.: US 2023/0021806 A1
(43) Pub. Date: Jan. 26, 2023

(54) DISTRIBUTED STORAGE SYSTEM AND VOLUME MANAGEMENT METHOD

(71) Applicant: Hitachi, Ltd., Tokyo (JP)

(72) Inventors: Yuki Sakashita, Tokyo (JP); Takahiro Yamamoto, Tokyo (JP); Shintaro Ito, Tokyo (JP); Masakuni Agetsuma, Tokyo (JP)

(73) Assignee: Hitachi, Ltd., Tokyo (JP)

(21) Appl. No.: 17/692,355

(22) Filed: Mar. 11, 2022

(30) Foreign Application Priority Data
Jul. 21, 2021 (JP) 2021-120399

(51) Int. Cl. G06F 9/50

(52) U.S. Cl. CPC G06F 9/5077; G06F 9/5016; G06F 9/505; G06F 9/5083

(57) ABSTRACT

In a distributed storage system that has a plurality of computer nodes having processors and a storage drive and that provides a volume, each of the plurality of computer nodes provides a sub-volume, the processor of the computer node manages settings of each sub-volume of the computer node, the volume can be configured by using a plurality of sub-volumes provided by the plurality of computer nodes, and the sub-volumes include a plurality of logical storage areas formed by being allocated with physical storage areas of the storage drive. The plurality of computer nodes move the logical storage areas between the sub-volumes that belong to the same volume and that are provided by different computer nodes.

### BACKGROUND OF THE INVENTION

### 1. Field of the Invention

The present invention relates to a distributed storage system including a plurality of nodes that have processors and memories and that are connected with each other by a network, and to a volume management method in the distributed storage system.

### 2. Description of the Related Art

Software Defined Storage (SDS) and Hyper-converged Infrastructure (HCI) are systems that provide distributed storage functionalities by causing storage control software having functionalities as a storage to operate on a plurality of storage nodes (or simply nodes) connected by a network, and allowing the plurality of storage nodes to operate in a mutually coordinated manner.

Such systems have functionalities of presenting the capacities of a plurality of storage devices included in the nodes as one combined virtual storage pool. A plurality of logical capacities are cut out as volumes from the storage pool, and can be presented as logical storage devices to a host.

For example, Japanese Patent No. 4963892 discloses a technology of bundling a plurality of volumes (local logical devices (LDEVs) in the document) cut out by a storage, and presenting, to a host, the plurality of volumes as one large volume (a global LDEV in the document). By applying this technology to SDS, it becomes possible to form, as one large volume, volumes included in nodes in a distributed manner, and present the one large volume to a host.

### SUMMARY OF THE INVENTION

However, in a case where a scalable volume is formed in a plurality of nodes in a distributed manner by using the technology described in Japanese Patent No. 4963892, if the number of volumes managed by storage control software operating on each storage node increases, control information to be managed increases, and the processing amount of the storage control software increases undesirably. On the other hand, there is a problem that, if the number of the volumes managed by the storage control software is reduced without changing the overall amount of the volumes, the size of each volume increases, making it difficult to migrate data between storage nodes flexibly.

The present invention has been made taking the points mentioned above into consideration, and attempts to propose a distributed storage system and a volume management method that make it possible to scale out the capacity and/or performance of one volume in association with addition of a computer node even if the one volume is formed in one or more nodes in a distributed manner.

In order to solve the problem, the present invention provides a distributed storage system that has a plurality of computer nodes having processors, and a storage drive, and provides a volume. In the distributed storage system, each of the plurality of computer nodes provides a sub-volume, the processor of the computer node manages settings of each sub-volume of the computer node, the volume can be configured by using a plurality of sub-volumes provided by the plurality of computer nodes, the sub-volumes include a plurality of logical storage areas formed by being allocated with physical storage areas of the storage drive, and the plurality of computer nodes move the logical storage areas between the sub-volumes that belong to the same volume but are provided by different computer nodes.

In addition, in order to solve the problem, the present invention provides a volume management method performed by a distributed storage system that has a plurality of computer nodes having processors, and a storage drive, and that provides a volume. In the distributed storage system, each of the plurality of computer nodes provides a sub-volume, the processor of the computer node manages settings of each sub-volume of the computer node, the volume can be configured by using a plurality of sub-volumes provided by the plurality of computer nodes, the sub-volumes include a plurality of logical storage areas formed by being allocated with physical storage areas of the storage drive, and the plurality of computer nodes move the logical storage areas between the sub-volumes that belong to the same volume but are provided by different computer nodes.

According to the present invention, the capacity and/or performance of one volume can be scaled out in association with addition of a computer node even if the one volume is formed in one or more nodes in a distributed manner.

### BRIEF DESCRIPTION OF THE DRAWINGS

FIG. 1 is a block diagram depicting a configuration example of a distributed storage system according to one embodiment of the present invention;

FIG. 2 is a figure depicting an example of a software stack of each node included in the distributed storage system;

FIG. 3 is a figure for explaining a relation between data management areas for volumes;

FIG. 4 is a figure depicting an example of programs and tables stored on a memory;

FIG. 5 is a figure depicting a configuration example of a cluster configuration management table;

FIG. 6 is a figure depicting a configuration example of a rebalancing policy management table;

FIG. 7 is a figure depicting a configuration example of a cluster pool management table;

FIG. 8 is a figure depicting a configuration example of a node pool management table;

FIG. 9 is a figure depicting a configuration example of a data area management table;

FIG. 10 is a figure depicting a configuration example of a host path management table;

FIG. 11 is a figure depicting a configuration example of a hardware (HW) monitor information management table;

FIG. 12 is a figure depicting a configuration example of a data area monitor information management table;

FIG. 13 is a flowchart depicting a process procedure example of a volume creation process;

FIG. 14 is a flowchart depicting a process procedure example of a write input/output (IO) process;

FIG. 15 is a flowchart depicting a process procedure example of a read IO process;

FIG. 16 is a flowchart depicting a process procedure example of a rebalancing process;

FIG. 17 is a flowchart depicting a process procedure example of a capacity rebalancing process;

FIG. 18 is a flowchart depicting a process procedure example of a load rebalancing process;

FIG. 19 is a flowchart depicting a process procedure example of a node adding/removing process;

FIG. 20 is a flowchart depicting a process procedure example of a distributed node count changing process; and

FIG. 21 is a flowchart depicting a process procedure example of a volume size-changing process.

### DESCRIPTION OF THE PREFERRED EMBODIMENT

One embodiment of the present invention is explained below with reference to the figures. Note that an embodiment explained below does not limit the invention related to claims, and all the combinations of features explained in the embodiment are not necessarily essential to the solution of the invention. Whereas various types of information are explained by using such expressions as “table,” “list,” or “queue” in the following explanation in some cases, the various types of information may be expressed by data structures other than these. In order to clarify that the various types of information do not depend on data structures, an “XX table,” an “XX list,” and the like are called “XX information” in some cases. Whereas such expressions as “identification information,” “identifier,” “name,” “ID,” and “number” are used when the content of each piece of information is explained, these expressions are interchangeable.

In the present embodiment, a distributed storage system is disclosed. First, a basic explanation regarding the distributed storage system is given.

A distributed storage system includes a plurality of computers for storage that are connected by a network with each other. Each of the computers includes a storage device, a processor, and the like. Each computer is also called a node or a computer node in the network. Each computer included in the distributed storage system is also called a storage node, particularly, and each computer included in a computing cluster is also called a computing node.

On the storage nodes included in the distributed storage system, an Operating System (OS) for managing and controlling the storage nodes is installed, and the distributed storage system is configured by causing storage software having a storage system functionality to operate on the OS. The distributed storage system can be configured also by causing the storage software to operate in the form of a container on the OS. A container is a mechanism for packaging one or more pieces of software and configuration information. In addition, the distributed storage system can also be configured by installing a Virtual Machine Monitor (VMM) on the storage nodes, and causing the OS and software to operate as a Virtual Machine (VM).

In addition, the present invention can also be applied to a case where a system called an HCI is configured. An HCI is a system that enables implementation of a plurality of processes with use of one node by causing applications, middleware, management software, and a container to operate, in addition to storage software, on an OS or a hypervisor installed on each node.

The distributed storage system provides a host (computing node) with a logical volume (also simply called a volume) and a storage pool virtualizing the capacities of the storage devices on the plurality of storage nodes. When the host gives IO for any of the storage nodes, the distributed storage system transfers the IO command to a storage node retaining data specified by the IO command, and thereby allows the host to access data. This feature allows the distributed storage system to move a volume between storage nodes without stopping the IO command from the host.

A manager of the distributed storage system gives a management command to the distributed storage via the network, and can thereby implement such processes as creation, removal, or movement of volumes. In addition, the distributed storage system provides, via the network, information it transmits, and can thereby notify the manager or management tools of the state of the distributed storage system such as the status of use of drives or the status of use of processors in the distributed storage system.

A distributed storage system 1 according to the present embodiment is explained in detail below.

### (1) System Configuration

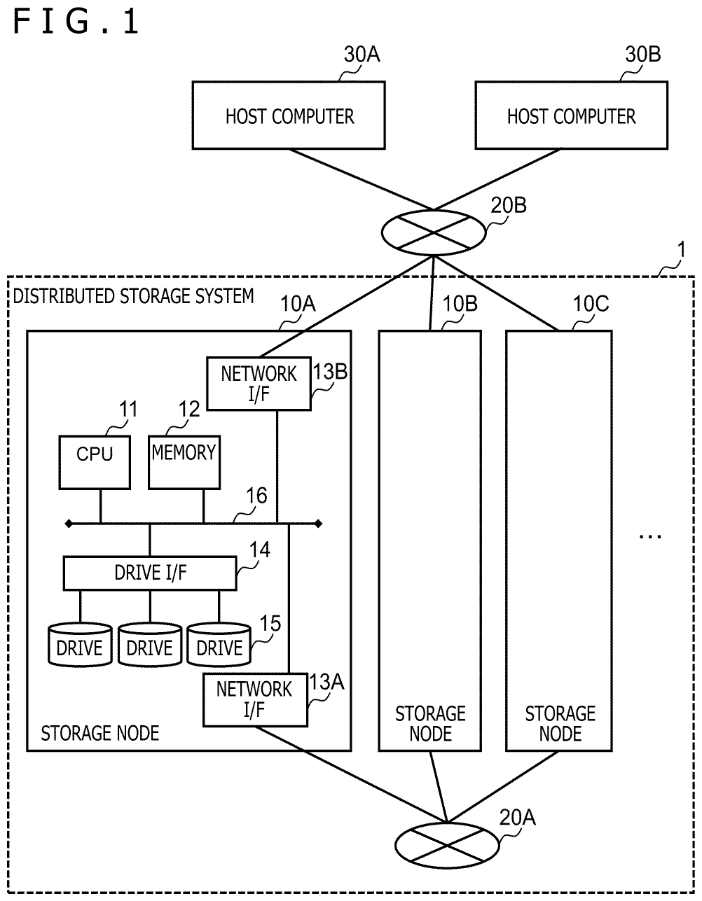

FIG. 1 is a block diagram depicting a configuration example of the distributed storage system 1 according to one embodiment of the present invention. As depicted in FIG. 1, the distributed storage system 1 includes a plurality of storage nodes 10 (alternatively, referred to as nodes) that are connected with each other by a network 20A. The hardware configuration of each storage node 10 is not limited to any particular configuration, but, for example, as with the case of a storage node 10A depicted in FIG. 1, each storage node 10 has a Central Processing Unit (CPU) 11, a memory 12, network interfaces (I/F) 13, a drive interface 14, drives 15, an internal network 16, and the like. For example, the storage node 10A is connected to the network 20A via a network I/F 13A, and communicates with other storage nodes 10B and 10C. Note that, in a case where internal configurations of the distributed storage system 1 are denoted as “nodes” in the explanation of the present embodiment, it may be understood that the “nodes” are the “storage nodes 10” unless otherwise noted.

Note that, although omitted in FIG. 1, the network 20A connecting the plurality of storage nodes 10 included in the distributed storage system 1 may include a plurality of connected networks 20 on the same tier or on different tiers. Geographic distances between the plurality of networks 20A are not limited to any distance. In addition, whereas the storage nodes 10A to 10C are depicted as examples of the storage nodes 10 included in the distributed storage system 1 in FIG. 1, the distributed storage system 1 according to the present embodiment may include any number of storage nodes 10. Accordingly, for example, if the network 20 connecting the storage nodes 10A to 10C is connected to a second network 20 configured at a geographically sufficiently remote place and a storage node 10D and a storage node 10E are connected to the second network 20, data in the storage nodes 10A to 10C can be stored also on the storage nodes 10D and 10E as a measure in preparation for disasters.

Host computers 30A and 30B access the distributed storage system 1 via a network 20B. Whereas the networks 20 are constructed separately for communication between the storage nodes 10 and communication with the host computers 30 in the form in the present embodiment, the networks 20 can also be a single network. In addition, whereas all nodes included in the distributed storage system 1 are the storage nodes 10 in FIG. 1, nodes that can be included in the distributed storage system 1 in the present embodiment are not limited to storage nodes, and, for example, such nodes as HCI nodes that cause computing functionalities to operate on the same nodes may be included in the distributed storage system 1.

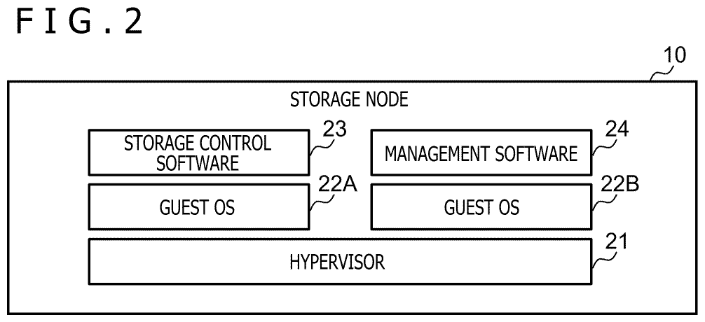

FIG. 2 is a figure depicting an example of a software stack of each node included in the distributed storage system 1. As depicted in FIG. 2, a hypervisor 21 for controlling hardware is operating on one storage node 10, and one or more guest OSs 22 (separately, guest OSs 22A and 22B) are operating thereon. It is possible to cause storage control software 23 or management software 24 to operate on each guest OS 22. It is also possible to cause computing software to operate on the hypervisor 21, and, in that case, it is also possible to configure a system as an HCI.

Note that the storage control software 23 and the management software 24 need not necessarily be caused to operate on all the storage nodes 10. In addition, it is also possible to cause the management software 24 to operate on a server other than storage nodes.

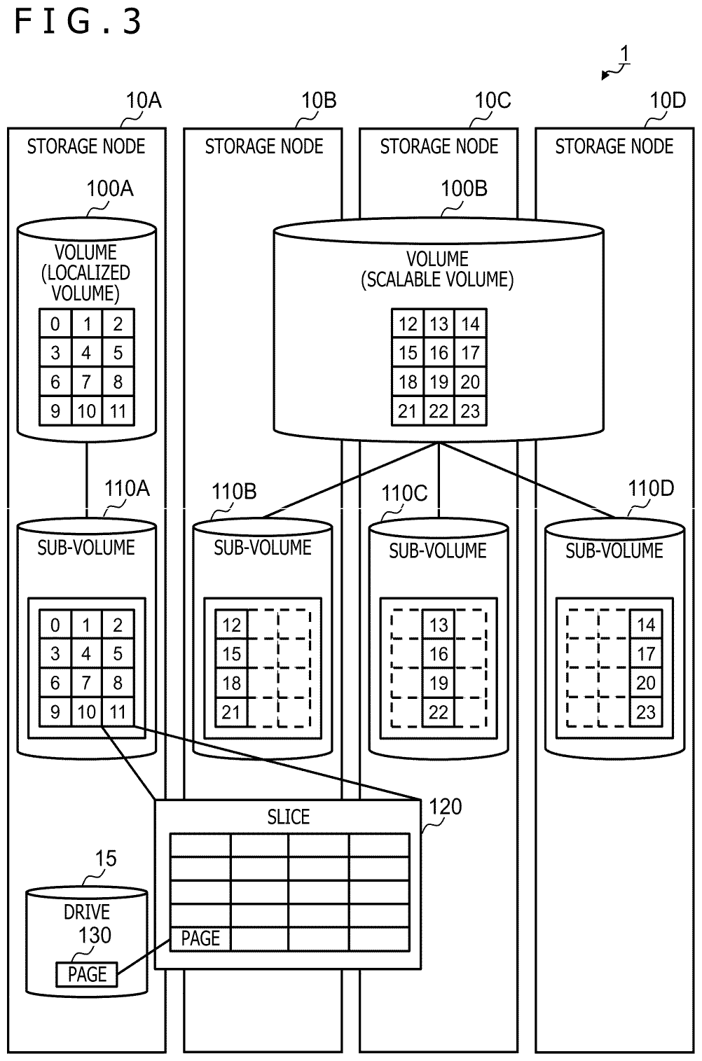

FIG. 3 is a figure for explaining a relation between data management areas for volumes 100. FIG. 3 depicts an example of a relation between data management areas in the distributed storage system 1 for the volumes 100 (separately, volumes 100A and 100B) formed in the distributed storage system 1.

A volume 100 is a data management area that the distributed storage system 1 presents to a host computer 30. A sub-volume 110 is a data management area managed by the storage control software 23 at each storage node 10, and a volume 100 is associated with one or more sub-volumes 110.

The storage control software 23 retains management information for each sub-volume 110. When the number of sub-volumes 110 managed by the storage control software 23 at one storage node 10 increases, the length of time for such operation as creation, update, or removal increases, and hence, it is desirable that the number of sub-volumes 110 created by each storage node 10 be small. However, in a case where the number of sub-volumes 110 of each storage node 10 is small, a problem related to a volume scale-out process occurs as explained below.

A volume scale-out process is a process of offloading loads of IO processes by migrating, when a storage node 10 is added newly to the distributed storage system 1, part of the data in a volume 100 to the added storage node 10. At this time, in a case where the number of sub-volumes 110 belonging to each storage node 10 is small, that is, in a case where the capacity per one sub-volume 110 is large, it can be expected that the migration causes a problem that the part of the data cannot be migrated flexibly to the added storage node 10 for such reasons as a large load of the migration itself or a scarcity of the resources of the migration destination due to the large capacity.

In order to solve the problems in a volume scale-out process as the one described above, a concept of slices 120 is introduced into the distributed storage system 1 according to the present embodiment.

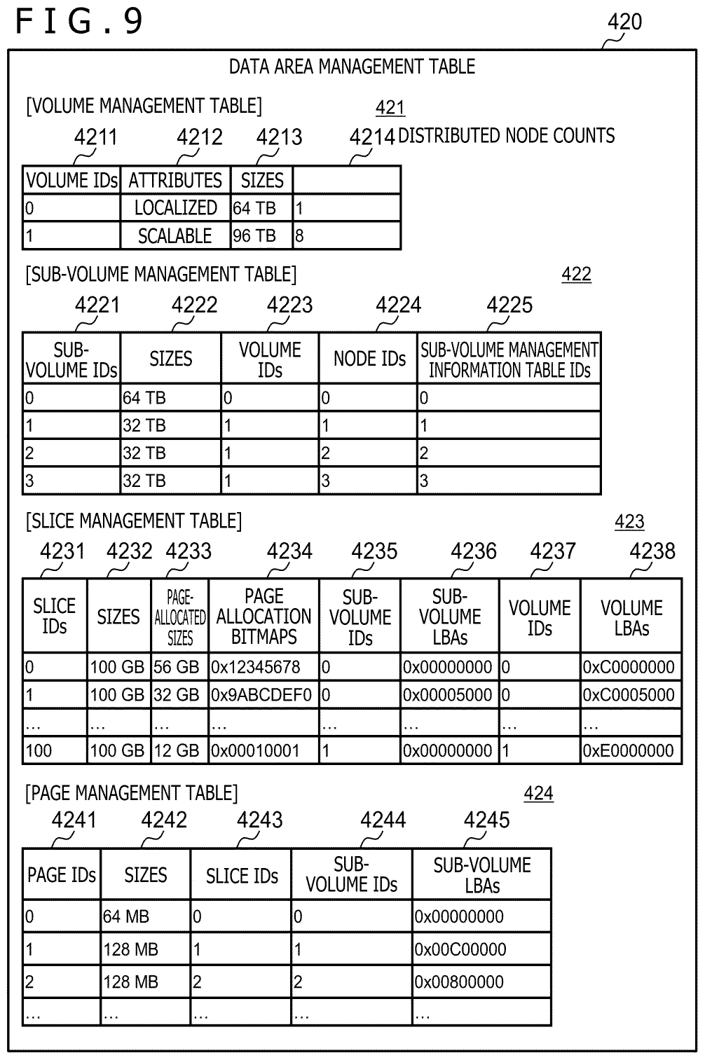

A slice 120 is a fixed-sized data area having a size larger than the management size of data stored in a volume (e.g., one byte) but smaller than the size of sub-volumes 110 (e.g., the minimum size is 32 TB in the case of FIG. 9 mentioned later), and the size of the slice 120 is set to 100 GB when a slice management table 423 in a data area management table 420 in FIG. 9 mentioned later is referred to. As depicted in FIG. 3, a volume 100 is mapped to sub-volumes 110 in units of slices 120. That is, the effective capacity of each sub-volume 110 is defined by the total value (also referred to as the total slice size below) of slices 120 allocated to the sub-volume 110, and, in other words, is the same size as the capacity of the volume 100. Specifically, for example, in the case of FIG. 3, the volume 100B formed in the storage nodes 10B to 10D in a distributed manner has a capacity equivalent to 12 slices 120, “12” to “23.” Sub-volumes 110B to 110D having the same size as the volume 100B are formed in the storage nodes 10B to 10D, respectively, and each of the sub-volumes 110B to 110D is subdivided into 12 slices 120. The logical data area of the volume 100 is configured by having the slices 120 of each of the sub-volumes 110B to 110D partially allocated thereto (e.g., by having four slices 120 of each of the sub-volumes 110B to 110D allocated thereto).

In addition, mapping of slices 120 to sub-volumes 110 is statically decided by, for example, the storage control software 23 when a volume 100 and the sub-volumes 110 are defined. That is, the process of mapping slices 120 is not executed at every instance of IO. Accordingly, as compared with dynamic mapping, slices 120 allow fast access.

By introducing such a concept of slices 120, the distributed storage system 1 can realize, in a case where a storage node 10 is added, a flexible scale-out process while the number of sub-volumes 110 to be created in each storage node 10 is kept small (in principle, one), by migrating one or more slices 120 to a sub-volume 110 on the added storage node 10.

At this time, by setting the size of sub-volumes 110 to the same size as a volume 100, it becomes possible also to move all slices 120 related to the volume 100 to one sub-volume 110, while it becomes unnecessary to change the size of the sub-volume 110 upon migration of the slices 120, making it possible to flexibly move slices 120 between sub-volumes 110. Even in the case of such a scheme, the size of sub-volumes 110 can be defined only by defining logical spaces for the sub-volumes 110 with use of a known technology generally called thin provisioning, and so the physical capacity is not consumed unnecessarily.

In one method that can be adopted, for example, the size of slices 120 is decided such that the size of a data area management table computed from the expected number of sub-volumes 110 does not exceed the size of the memory 12 mounted on each storage node 10, or other methods can be adopted.

Each slice 120 is subdivided into pages 130 which are physical data areas. In the technology of thin provisioning, in a case where data is written in a data area for the first time, a physical data area is allocated dynamically to the logical data area. Data areas are allocated at this time in units of “pages.”

FIG. 3 depicts the volume 100A formed in the one storage node 10A and the volume 100B formed in the plurality of storage nodes 10B, 10C, and 10D in a distributed manner. The volume 100A is associated with one sub-volume 110A, and the volume 100B is associated with the sub-volumes 110B, 110C, and 110D.

A volume as the volume 100A having slices 120 which belong to the one volume 100 and are entirely mapped only to one sub-volume 110 is called a localized volume. In addition, a volume as the volume 100B having slices 120 which belong to the one volume 100 but are mapped to a plurality of sub-volumes 110 is called a scalable volume.

The advantage of the localized volume is that, because an IO process is executed only at one node, the CPU process time is relatively short, and also because data transfer between nodes does not occur, the latency can be made short. The advantage of the scalable volume is that, because an IO process of one volume is executed at a plurality of nodes, the throughput of the volume is scaled up.

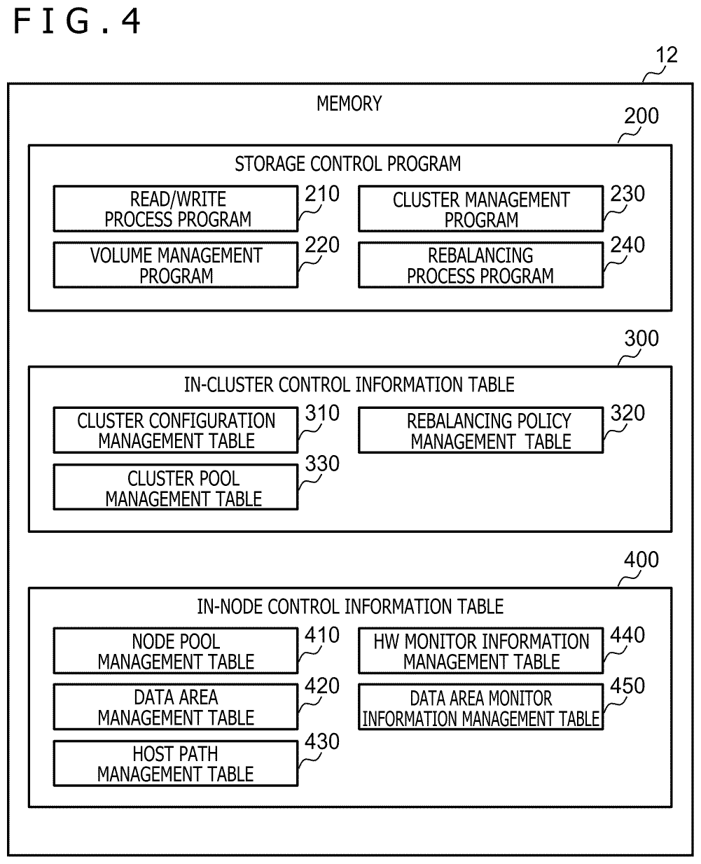

FIG. 4 is a figure depicting an example of programs and tables stored on a memory 12. Details of each table are mentioned later, and an overview is explained here.

As depicted in FIG. 4, a storage control program 200, an in-cluster control information table 300, and an in-node control information table 400 are stored on the memory 12 of a storage node 10.

The storage control program 200 operates on each storage node 10, and provides an identical storage functionality for each storage node 10. The storage control program 200 includes a read/write process program 210, a volume management program 220, a cluster management program 230, and a rebalancing process program 240.

The read/write process program 210 is a program that executes a process corresponding to a read/write command given from a host computer 30. For example, in a case where the host computer 30 accesses data in the distributed storage system 1 in accordance with such a protocol as Small Computer System Interface (SCSI), the read/write process program 210 provides a read or write of the data in accordance with the protocol.

The volume management program 220 is a program that operates in accordance with a volume management command which is an instruction given from a storage manager (e.g., volume creation, volume removal, volume settings change, etc.).

The cluster management program 230 is a program that operates in accordance with a cluster management command which is an instruction given from a storage manager (e.g., cluster creation, node addition/removal, cluster policy settings change, etc.).

The rebalancing process program 240 is a program that executes a rebalancing process. The rebalancing process is a process of migrating data to another appropriate node in a case where the system load or the amount of used data capacity has exceeded a threshold at a storage node 10.

It should be noted that a method of deciding the abovementioned threshold which is used as a reference value for execution of the rebalancing process is not limited to any particular method. Specifically, for example, there are a plurality of possible setting methods such as a method in which an absolute value such as 80% is set as a threshold concerning the resource usage at the storage node 10 or a method in which such a relative value as one that is higher than 20% or more than the average value of the resource usage of all nodes is set as a threshold. Note that the resource usage at storage nodes 10 can include not only load-related usage such as CPU usage or network bandwidth usage, but also the capacity usage of the drives, and the like.

Note that, whereas it is supposed that the storage control program 200 is retained in each storage node 10 in the explanation described above, a concept of a master node may be used in a case where overall processes in the distributed storage system 1 are necessary. Typically, the master node is properly specified from a plurality of nodes (storage nodes 10), and in a case where the master node becomes unavailable, another node performs overall processes in place of the master node. These technologies are widely known existing technologies, and hence, explanations of details are omitted.

The in-cluster control information table 300 is a table that manages control information regarding configurations and settings of a cluster of the distributed storage system 1, and is shared by the storage nodes 10. That is, the consistency of information in the in-cluster control information table 300 in the storage nodes 10 is kept such that the same information can be referred to no matter which storage node 10 accesses the in-cluster control information table 300 by using the storage control program 200 operating thereon. The in-cluster control information table 300 includes a cluster configuration management table 310, a rebalancing policy management table 320, and a cluster pool management table 330.

The cluster configuration management table 310 is a table that manages a list of storage nodes 10 included in the distributed storage system 1, the hardware configurations that the storage nodes 10 have, and the like.

The rebalancing policy management table 320 is a table that manages settings of rebalancing policies in the distributed storage system 1. The rebalancing policies are settings prepared for making operation policies of a user reflected in the rebalancing process.

The cluster pool management table 330 is a management table for managing the capacity of the whole cluster, and represents the capacity status of each storage pool.

The in-node control information table 400 is a table that manages control information of each storage node 10. The in-node control information table 400 includes a node pool management table 410, a data area management table 420, a host path management table 430, an HW monitor information management table 440, and a data area monitor information management table 450.

The node pool management table 410 is a table that manages the capacity of each storage node 10. While the cluster pool management table 330 represents the capacity status of each storage pool, the node pool management table 410 represents the capacity status of each storage node 10.

The data area management table 420 is a table that manages each data area such as a volume 100, a sub-volume 110, a slice 120, or a page 130. The data area management table 420 manages such information as an identification (ID) or the size of each data area, and, in addition to this, also manages a relation between data areas.

The host path management table 430 is a table that manages information regarding a path established between a host computer 30 and each storage node 10.

The HW monitor information management table 440 represents the load status of HW mounted on each storage node 10.

The data area monitor information management table 450 represents the load status of each data area of sub-volumes 110 and slices 120.

### (2) Data Structures

### (2-1) In-Cluster Control Information Table 300

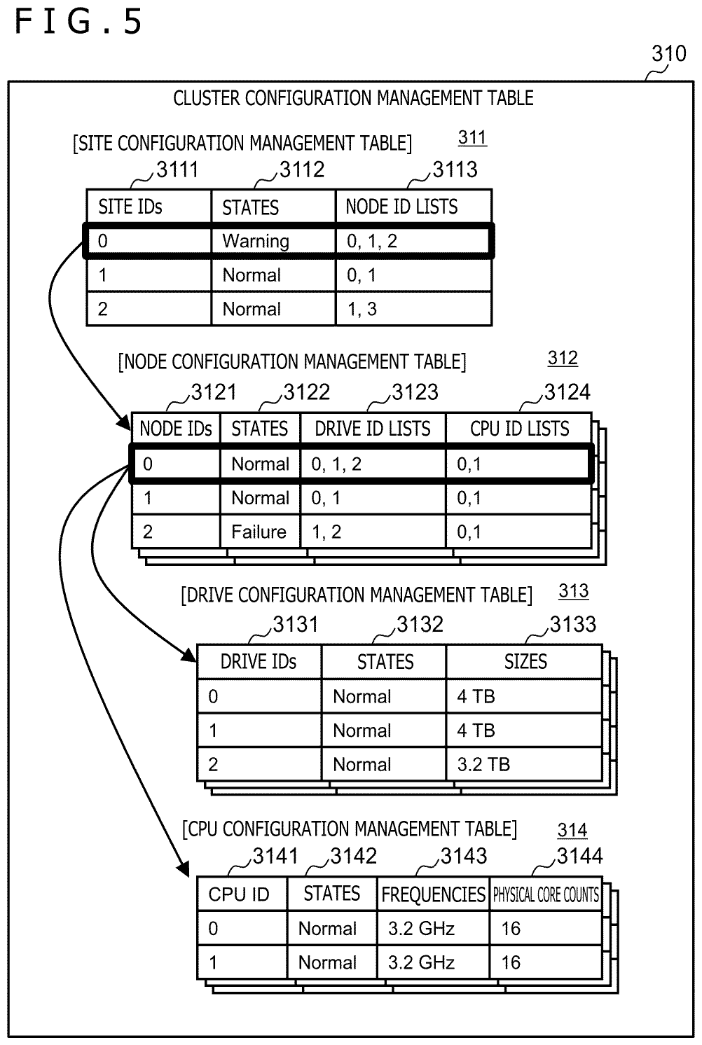

FIG. 5 is a figure depicting a configuration example of the cluster configuration management table 310. The cluster configuration management table 310 is a table that belongs to the in-cluster control information table 300, and manages information shared by the storage nodes 10.

As depicted in FIG. 5, the cluster configuration management table 310 internally includes a site configuration management table 311, node configuration management tables 312, drive configuration management tables 313, and CPU configuration management tables 314.

Sites are a concept representing places defined by a user such as the positions of a data center and server racks, for example. In the distributed storage system 1, by managing the states of sites with use of the site configuration management table 311, a cluster including the storage nodes 10 arranged at a plurality of sites can be defined.

The site configuration management table 311 manages sites included in the cluster of the distributed storage system 1, and their states. The site configuration management table 311 has fields of site IDs 3111, states 3112, and node ID lists 3113.

The fields of the site IDs 3111 manage identifiers (site IDs) that identify the sites. The fields of the states 3112 manage the states of the sites. Specifically, in a case where the value of a field of the states 3112 is “Normal,” this represents that the site of interest is at the normal state, and in a case where the value is “Warning,” this represents that the site of interest is at a state where the redundancy has lowered for such a reason as an occurrence of a partial failure of components in the site of interest, in other words, at a “partially failed state.”

The fields of the node ID lists 3113 manage IDs of storage nodes 10 included in each site. The IDs in the fields of the node ID lists 3113 correspond to records in the fields of node IDs 3121 in the node configuration management tables 312 mentioned later.

Each node configuration management table 312 manages the state of each storage node 10, and IDs of resources such as the drives 15 or the CPU 11 mounted on each storage node 10. The node configuration management table 312 has fields of node IDs 3121, states 3122, drive ID lists 3123, and CPU ID lists 3124.

The fields of the node IDs 3121 manage identifiers (node IDs) that identify the nodes. The fields of the states 3122 manage the states of the nodes. Specifically, in a case where the value of a field of the states 3122 is “Normal,” this represents that the node of interest is at the “normal state,” and in a case where the value is “Failure,” this represents that the node of interest is at the “stopped state” for such a reason as a fault.

The fields of the drive ID lists 3123 manage identifiers (drive IDs) that identify the drives 15 mounted on each storage node 10. The IDs in the fields of the drive ID lists 3123 correspond to records in fields of drive IDs 3131 in the drive configuration management tables 313 mentioned later.

The fields of the CPU ID lists 3124 manage identifiers (CPU IDs) that identify the CPU 11 mounted on each storage node 10. The IDs in the fields of the CPU ID lists 3124 correspond to records in fields of CPU IDs 3141 in the CPU configuration management tables 314 mentioned later.

Each drive configuration management table 313 is a table that manages the configuration of the drives 15 included in a corresponding one of the nodes managed in a corresponding one of the node configuration management tables 312, and has fields of drive IDs 3131, states 3132, and sizes 3133.

The fields of the drive IDs 3131 manage drive IDs that identify the drives 15. The fields of the states 3132 manage the states of the drives 15. The fields of the sizes 3133 manage the capacities (sizes) of the drives 15.

Each CPU configuration management table 314 is a table that manages the configuration of the CPU 11 included in a corresponding one of the nodes managed in a corresponding one of the node configuration management tables 312, and has fields of CPU IDs 3141, states 3142, frequencies 3143, and physical core counts 3144.

The fields of the CPU IDs 3141 manage CPU IDs that identify the CPUs 11. The fields of the states 3142 manage the states of the CPUs 11. The fields of the frequencies 3143 manage the clock frequencies of the CPUs 11. The fields of the physical core counts 3144 manage the physical core counts of the CPUs 11.

Note that whereas FIG. 5 depicts the drive configuration management tables 313 as configuration management tables for the drives 15, and the CPU configuration management tables 314 as configuration management tables for the CPUs 11, the actual cluster configuration management table 310 may also include configuration management tables that manage such resources as the memories 12 or network cards.

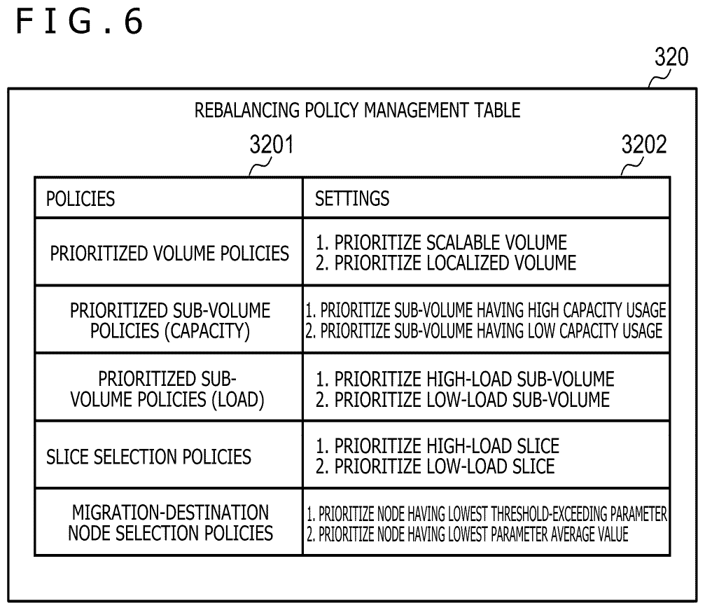

FIG. 6 is a figure depicting a configuration example of a rebalancing policy management table 320. The rebalancing policy management table 320 is a table that belongs to the in-cluster control information table 300, and manages information shared by the storage nodes 10.

The rebalancing policies are items that are set for the purpose of making policies related to operation of a user in the rebalancing process reflected. Whereas FIG. 6 depicts a plurality of policies as an example, these are not all that is necessary and sufficient, other policies may be set, and some policies may not be included.

For example, for a volume 100 aimed for a particular use, as mentioned before, the rebalancing process is implemented when a parameter (the CPU usage, network bandwidth usage, drive capacity usage, etc.) of any of storage nodes 10 has exceeded a threshold. At that time, in accordance with the rebalancing policies, the rebalancing process program 240 selects a volume 100, a sub-volume 110, and slices 120 belonging to the storage node 10, further selects a migration-destination node, and then executes migration of the slices 120.

The rebalancing policy management table 320 has fields of policies 3201 and settings 3202. The fields of the policies 3201 manage policies to be applied to the rebalancing process. The fields of the settings 3202 manage the settings content of each policy. In the case of FIG. 6, five types of policies, “Prioritized Volume Policies,” “Prioritized Sub-Volume Policies (Capacity),” “Prioritized Sub-Volume Policies (Load),” “Slice Selection Policies,” and “Migration-Destination Node Selection Policies,” are described in the fields of the policies 3201.

The prioritized volume policies are policies regarding what type of volume 100 is to be selected in a prioritized manner when the rebalancing process is executed. For example, in a case where a scalable volume (volume 100B) is selected in a prioritized manner, “1. Prioritize Scalable Volume” in the settings 3202 in “Prioritized Volume Policies” is set.

The prioritized sub-volume policies (capacity) are policies regarding what type of sub-volume 110 is to be selected in a prioritized manner in terms of data capacity from sub-volumes 110 included in the selected volume 100. For example, in a case where a solution is desired for a sub-volume 110 having high capacity usage, in a prioritized manner, “1. Prioritize Sub-Volume Having High Capacity Usage” in the settings 3202 in “Prioritized Sub-Volume Policies (Capacity)” is set.

The prioritized sub-volume policies (load) are policies regarding what type of sub-volume 110 is to be selected in a prioritized manner in terms of system load from sub-volumes 110 included in the selected volume 100. For example, in a case where a solution is desired for a sub-volume 110 having a high load, in a prioritized manner, “1. Prioritize High-Load Sub-Volume” in the settings 3202 in “Prioritized Sub-Volume Policies (Load)” is set.

The slice selection policies are policies regarding which slice 120 is to be selected in a prioritized manner in the selected sub-volume 110 when the rebalancing process is executed. For example, in a case where it is desired to select, in a prioritized manner, a slice 120 having the highest load, and perform migration starting from the slice 120, “1. Prioritize High-Load Slice” in the settings 3202 of “Slice Selection Policies” is set.

The migration-destination node selection policies are policies regarding how a migration-destination node for the selected slice 120 is to be selected. For example, in a case where execution of the rebalancing process is triggered by an increase of the drive capacity usage of a storage node 10 that makes the drive capacity usage exceed a threshold when “1. Prioritize Node Having Lowest Threshold-Exceeding Parameter” has been set, a node having the lowest drive capacity usage is selected as a migration destination.

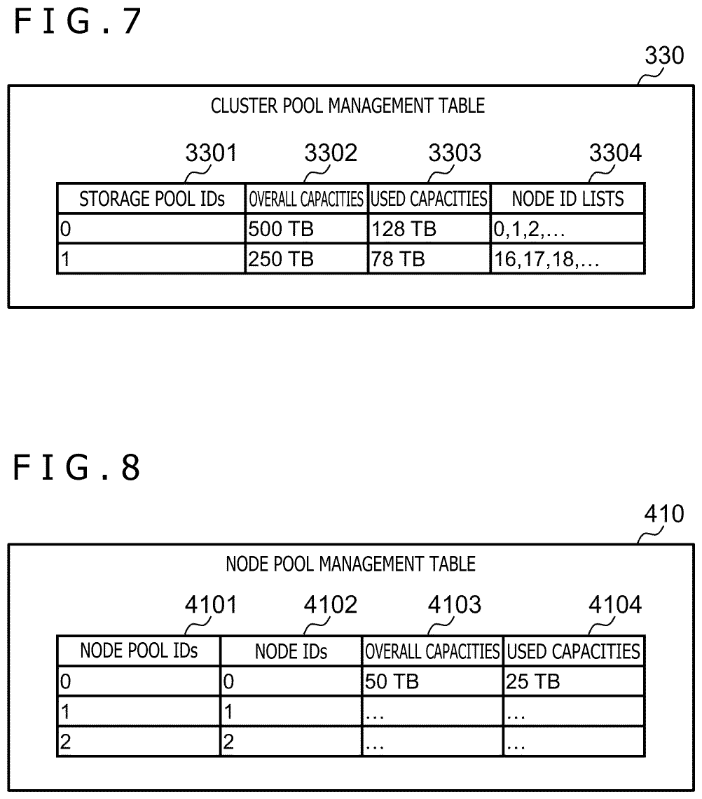

FIG. 7 is a figure depicting a configuration example of the cluster pool management table 330. The cluster pool management table 330 is a table that belongs to the in-cluster control information table 300, and manages information shared by the storage nodes 10.

The cluster pool management table 330 is a table for managing the capacity of the whole cluster, and represents the capacity status of each storage pool.

Pools include node pools and storage pools. While a node pool is a pool having the total capacity of drive capacities included in each storage node 10, a storage pool is a pool having the total capacity of a plurality of node pools. When capacity management of each node is performed in a case where the number of storage nodes 10 is large, operation becomes complicated. In view of this, the distributed storage system 1 according to the present embodiment makes it possible to simplify overall operation by introducing a superordinate concept which is storage pools.

The cluster pool management table 330 has fields of storage pool IDs 3301, overall capacities 3302, used capacities 3303, and node ID lists 3304. The fields of the storage pool IDs 3301 manage identifiers (storage pool IDs) that identify the storage pools. The fields of the overall capacities 3302 manage the overall capacities of the storage pools, and the fields of the used capacities 3303 manage used capacities that are being used in the storage pools. In addition, the fields of the node ID lists 3304 manage node IDs of storage nodes 10 sharing the storage pools.

Note that values described in the cluster pool management table 330 in FIG. 7 do not correspond to the configuration of the distributed storage system 1 depicted in FIG. 3. On the other hand, values in each table depicted as examples in FIG. 5, FIG. 6, and FIG. 8 to FIG. 12 generally correspond to the configuration of the distributed storage system 1 depicted in FIG. 3.

### (2-2) In-Node Control Information Table 400

FIG. 8 is a figure depicting a configuration example of the node pool management table 410. The node pool management table 410 is a table that belongs to the in-node control information table 400, and manages information managed only in each storage node 10.

The node pool management table 410 represents the capacity status of each node pool. As mentioned before in the explanation of the cluster pool management table 330 depicted in FIG. 7, a node pool is a pool having the total capacity of drive capacities of each storage node 10.

The node pool management table 410 has fields of node pool IDs 4101, node IDs 4102, overall capacities 4103, and used capacities 4104. The fields of the node pool IDs 4101 manage identifiers (node pool IDs) that identify the node pools. The fields of the node IDs 4102 manage node IDs of storage nodes 10 sharing the node pools. The fields of the overall capacities 4103 manage the overall capacities of the node pools, and the fields of the used capacities 4104 manage used capacities being used in the node pools.

FIG. 9 is a figure depicting a configuration example of the data area management table 420. The data area management table 420 is a table that belongs to the in-node control information table 400, and manages information managed only in each storage node 10.

As depicted in FIG. 9, the data area management table 420 internally includes a volume management table 421, a sub-volume management table 422, a slice management table 423, and a page management table 424.

The volume management table 421 is a table that manages configuration information of volumes 100 formed in the distributed storage system 1, and has fields of volume IDs 4211, attributes 4212, sizes 4213, and distributed node counts 4214.

The fields of the volume IDs 4211 manage identifiers (volume IDs) that identify the volumes 100. The fields of the attributes 4212 manage attributes of the volumes 100 (whether the volumes 100 are localized volumes or scalable volumes). The fields of the sizes 4213 manage the capacities (sizes) of the volumes 100. The fields of the distributed node counts 4214 manage the distribution counts of the volumes 100, that is, values representing how many nodes provide sub-volumes 110 for one volume 100. In a case where the value of a field of the attributes 4212 is “Localized,” the distribution count is “1,” and in a case where the value of a field of the attributes 4212 is “Scalable,” the distribution count is determined from the number of nodes included in a cluster, user settings, and the like.

The sub-volume management table 422 is a table that manages configuration information regarding each sub-volume 110 belonging to a volume 100, and has fields of sub-volume IDs 4221, sizes 4222, volume IDs 4223, node IDs 4224 and sub-volume management information table IDs 4225.

The fields of the sub-volume IDs 4221 manage identifiers (sub-volume IDs) that identify the sub-volumes 110. The fields of the sizes 4222 manage the capacities (sizes) of the sub-volumes 110. The fields of the volume IDs 4223 manage volume IDs of volumes 100 to which the sub-volumes 110 belong. The fields of the node IDs 4224 manage node IDs of storage nodes 10 on which the sub-volumes 110 are formed. The fields of the sub-volume management information table IDs 4225 manage identifiers of sub-volume management information tables storing control information for managing the sub-volumes 110. Note that whereas the sub-volume management information tables are tables that manage information regarding whether or not functionalities implemented by the storage control software 23 are to be applied and settings information related to the functionalities described above, an explanation based on a figure is omitted because the content of the sub-volume management information tables differs depending on the implementation form of the storage control software 23. For slices 120 in the sub-volumes 110, information regarding whether or not functionalities are applied according to the sub-volumes 110 and settings information related to the functionalities described above are set.

The slice management table 423 is a table that manages configuration information of the slices 120 allocated to the sub-volumes 110, and has fields of slice IDs 4231, sizes 4232, page-allocated sizes 4233, page allocation bitmaps 4234, sub-volume IDs 4235, sub-volume Logical Block Addresses (LBAs) 4236, volume IDs 4237, and volume LBAs 4238.

The fields of the slice IDs 4231 manage identifiers (slice IDs) that identify the slices 120. The fields of the sizes 4232 manage the capacities (sizes) of the slices 120.

The fields of the page-allocated sizes 4233 manage sizes to which pages 130 have already been allocated in the slices 120. The fields of the page allocation bitmaps 4234 manage bitmaps representing the pages 130 allocated in the slices 120. The bitmaps specifically represent allocated pages by using “1,” and represent unallocated pages by using “0.”

The fields of the sub-volume IDs 4235 manage sub-volume IDs of the sub-volumes 110 to which the slices 120 belong. The fields of the sub-volume LBAs 4236 manage LBAs representing the positions of the slices 120 in the sub-volumes 110 to which the slices 120 belong. The fields of the volume IDs 4237 manage volume IDs of the volumes 100 to which the slices 120 belong. The fields of the volume LBAs 4238 manage LBAs representing the positions of the slices 120 in the volumes 100 to which the slices 120 belong.

The page management table 424 is a table that manages configuration information regarding pages 130 which are physical data area corresponding to the slices 120, and has fields of page IDs 4241, sizes 4242, slice IDs 4243, sub-volume IDs 4244, and sub-volume LBAs 4245.

The fields of the page IDs 4241 manage identifiers (page IDs) that identify the pages 130. The fields of the sizes 4242 manage the capacities (sizes) of the pages 130.

The fields of the slice IDs 4243 manage slice IDs of the slices 120 corresponding to the pages 130. In the present embodiment, as an example, by setting the physical capacity of one page 130 and the logical capacity of one slice 120 to the same size, when a page 130 is allocated to a slice 120, the slice 120 and the page 130 having a corresponding relation can be managed in a one-to-one relationship.

The fields of the sub-volume IDs 4244 manage sub-volume IDs of sub-volumes 110 to which the pages 130 are allocated. The fields of the sub-volume LBAs 4245 manage LBAs representing the positions of the slices 120 in the sub-volumes 110 to which the pages 130 are allocated.

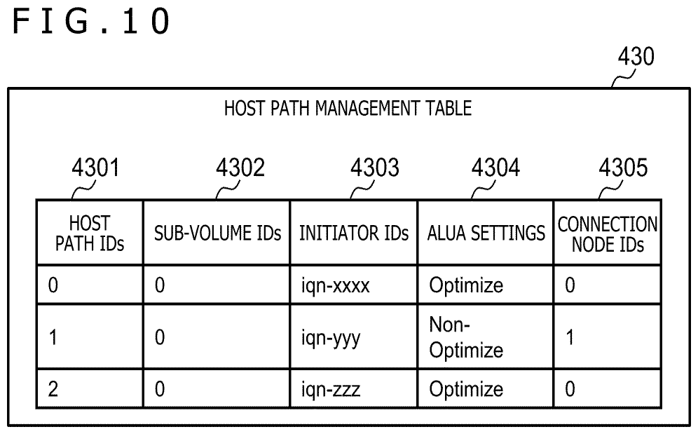

FIG. 10 is a figure depicting a configuration example of the host path management table 430. The host path management table 430 is a table that belongs to the in-node control information table 400, and manages information managed only in each storage node 10.

The host path management table 430 is a table that manages host paths, and has fields of host path IDs 4301, sub-volume IDs 4302, initiator IDs 4303, Asymmetric Logical Unit Access (ALUA) settings 4304, and connection node IDs 4305. The host paths are paths that are logically defined between initiators on host computers 30 and sub-volumes 110 belonging to storage nodes 10.

The fields of the host path IDs 4301 manage identifiers (host path IDs) that identify the host paths. The fields of the sub-volume IDs 4302 manage sub-volume IDs of sub-volumes 110 that are end points of the host paths. The fields of the initiator IDs 4303 manage identifiers (initiator IDs) that identify initiators that are end points of the host paths.

The fields of the ALUA settings 4304 manage settings of ALUA of the host paths. The settings of AULA are settings of paths that are used in a prioritized manner in host paths from initiators to sub-volumes 110. For example, for a localized volume as the volume 100A for which all slices 120 have been mapped to one sub-volume 110, only a host path to the sub-volume 110 is set to “Optimize (optimize),” thereby hindering transfer between storage nodes 10, and leading to a storage performance enhancement.

The fields of the connection node IDs 4305 manage node IDs of storage nodes 10 to which the host paths are connected.

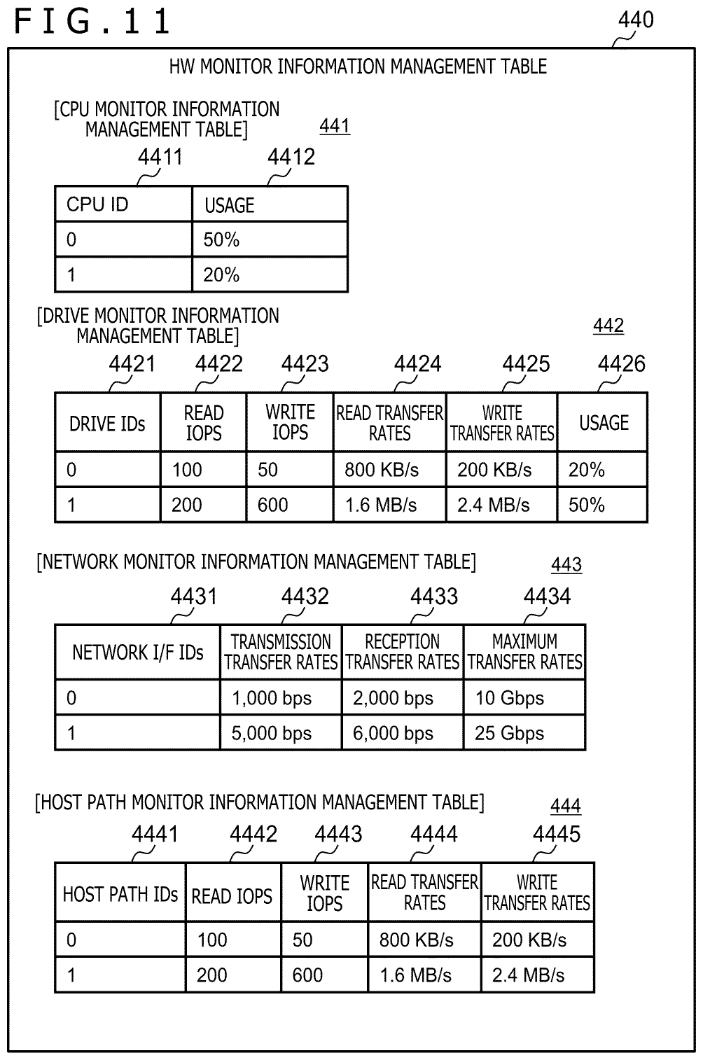

FIG. 11 is a figure depicting a configuration example of the HW monitor information management table 440. The HW monitor information management table 440 is a table that belongs to the in-node control information table 400, and manages information managed only in each storage node 10.

The HW monitor information management table 440 has internal tables mentioned later that store monitor information regarding hardware mounted on each storage node 10. In reference to the monitor information managed in such a HW monitor information management table 440, the distributed storage system 1 can monitor the load of each piece of HW mounted on a storage node 10, detects whether the load has exceeded a threshold in the monitoring, and can thereby execute the rebalancing process at an appropriate timing. Note that the information regarding the internal tables included in the HW monitor information management table 440 is updated regularly by a monitor functionality of the cluster management program 230. At the time of updating, instantaneous values that are obtained at the time of reference by the monitor functionality may be stored in the tables, or the average values or medians over a predetermined period may be stored therein, for example.

As depicted in FIG. 11, the HW monitor information management table 440 internally includes a CPU monitor information management table 441, a drive monitor information management table 442, a network monitor information management table 443, and a host path monitor information management table 444.

The CPU monitor information management table 441 is a table for managing monitor information regarding the CPUs 11 included in storage nodes 10, and has fields of CPU IDs 4411 and usage 4412.

The fields of the CPU IDs 4411 manage identifiers (CPU IDs) that identify the CPUs 11. The fields of the usage 4412 manage the CPU usage of the CPUs 11.

The drive monitor information management table 442 is a table for managing monitor information regarding the drives 15 included in storage nodes 10, and has fields of drive IDs 4421, read Input/Output Per Second (IOPS) 4422, write IOPS 4423, read transfer rates 4424, write transfer rates 4425, and usage 4426.

The fields of the drive IDs 4421 manage identifiers (drive IDs) that identify the drives 15 mounted on each storage node 10. The fields of the read IOPS 4422 manage IOPS of the drives 15 at the time of read IO processes. The fields of the write IOPS 4423 manage IOPS of the drives 15 at the time of write IO processes. The fields of the read transfer rates 4424 manage data transfer speeds (read transfer rates) of the drives 15 at the time of read IO processes. The fields of the write transfer rates 4425 manage data transfer speeds (write transfer rates) of the drives 15 at the time of write IO processes. The fields of the usage 4426 manage the capacity usage of the drives 15.

The network monitor information management table 443 is a table for managing monitor information regarding transfer rates (in the present example, transfer rates are represented by transfer speeds) of communication between storage nodes 10 via the network I/Fs 13A and the network 20A. The network monitor information management table 443 has fields of network I/F IDs 4431, transmission transfer rates 4432, reception transfer rates 4433, and maximum transfer rates 4434.

The fields of the network I/F IDs 4431 manage identifiers (network I/F IDs) that identify the network I/Fs 13A. The fields of the transmission transfer rates 4432 manage transfer speeds (transmission transfer rates) at the time of data transmission in communication between storage nodes 10 through the network I/Fs 13A. The fields of the reception transfer rates 4433 manage transfer speeds (reception transfer rates) at the time of data reception in communication between storage nodes 10 through the network I/Fs 13A. The fields of the maximum transfer rates 4434 manage the maximum speeds (maximum transfer rates) of transfer speeds in communication through the network I/Fs 13A.

The host path monitor information management table 444 is a table for managing monitor information regarding transfer rates of communication on host paths established between sub-volumes 110 and initiators belonging to host computers 30. The host path monitor information management table 444 has fields of host path IDs 4441, read IOPS 4442, write IOPS 4443, read transfer rates 4444, and write transfer rates 4445.

The fields of the host path IDs 4441 manage host path IDs that identify the host paths. Each ID in the fields of the host path IDs 4441 corresponds to a record in a field of the host path IDs 4301 in the host path management table 430.

The fields of the read IOPS 4442 manage IOPS of the host paths at the time of read IO processes. The fields of the write IOPS 4443 manage IOPS of the host paths in write IO processes. The fields of the read transfer rates 4444 manage data transfer speeds (read transfer rates) of the host paths at the time of read IO processes. The fields of the write transfer rates 4445 manage data transfer speeds (write transfer rates) of the host paths at the time of write IO processes.

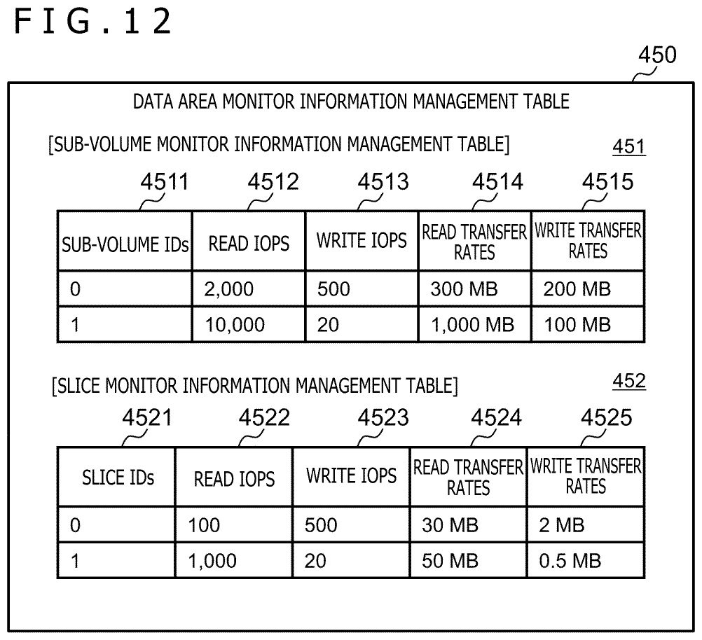

FIG. 12 is a figure depicting a configuration example of the data area monitor information management table 450. The data area monitor information management table 450 is a table that belongs to the in-node control information table 400, and manages information managed only in each storage node 10.

The data area monitor information management table 450 is a table that manages load information regarding each data area such as a sub-volume 110 or a slice 120, and, as depicted in FIG. 12, internally includes a sub-volume monitor information management table 451 and a slice monitor information management table 452.

By managing the load information regarding each data area in the data area monitor information management table 450, the distributed storage system 1 can select an appropriate data area in accordance with rebalancing policies of a user such as a high-load data area or a low-load data area at the time of the rebalancing process. Note that the data area monitor information management table 450 is updated explicitly by a component provided by the storage control software 23, for example.

The sub-volume monitor information management table 451 is a table that manages a load of an IO process of each sub-volume 110, and has fields of sub-volume IDs 4511, read IOPS 4512, write IOPS 4513, read transfer rates 4514, and write transfer rates 4515.

The fields of the sub-volume IDs 4511 manage sub-volume IDs that identify the sub-volumes 110. The fields of the read IOPS 4512 manage IOPS of the sub-volumes 110 at the time of read IO processes. The fields of the write IOPS 4513 manage IOPS of the sub-volumes 110 at the time of write IO processes. The fields of the read transfer rates 4514 manage data transfer speeds (read transfer rates) of the sub-volumes 110 at the time of read IO processes. The fields of the write transfer rates 4515 manage data transfer speeds (write transfer rates) of the sub-volumes 110 at the time of write IO processes.

The slice monitor information management table 452 is a table that manages load information of slices 120, and has fields of slice IDs 4521, read IOPS 4522, write IOPS 4523, read transfer rates 4524, and write transfer rates 4525.

The fields of the slice IDs 4521 manage slice IDs that identify the slices 120. The fields of the read IOPS 4522 manage IOPS of the slices 120 at the time of read IO processes. The fields of the write IOPS 4523 manage IOPS of the slices 120 at the time of write IO processes. The fields of the read transfer rates 4524 manage data transfer speeds (read transfer rates) of the slices 120 at the time of read IO processes. The fields of the write transfer rates 4525 manage data transfer speeds (write transfer rates) of the slices 120 at the time of write IO processes.

### (3) Processes

Process procedure examples of a volume creation process, a write IO process, a read IO process, a rebalancing process, a node adding/removing process, and a volume size-changing process are explained in detail below as data processes or data area management processes executed at the distributed storage system 1 according to the present embodiment. In an explanation of each process, configurations and such data as tables explained with reference to FIG. 1 to FIG. 12 are used as necessary.

### (3-1) Volume Creation Process

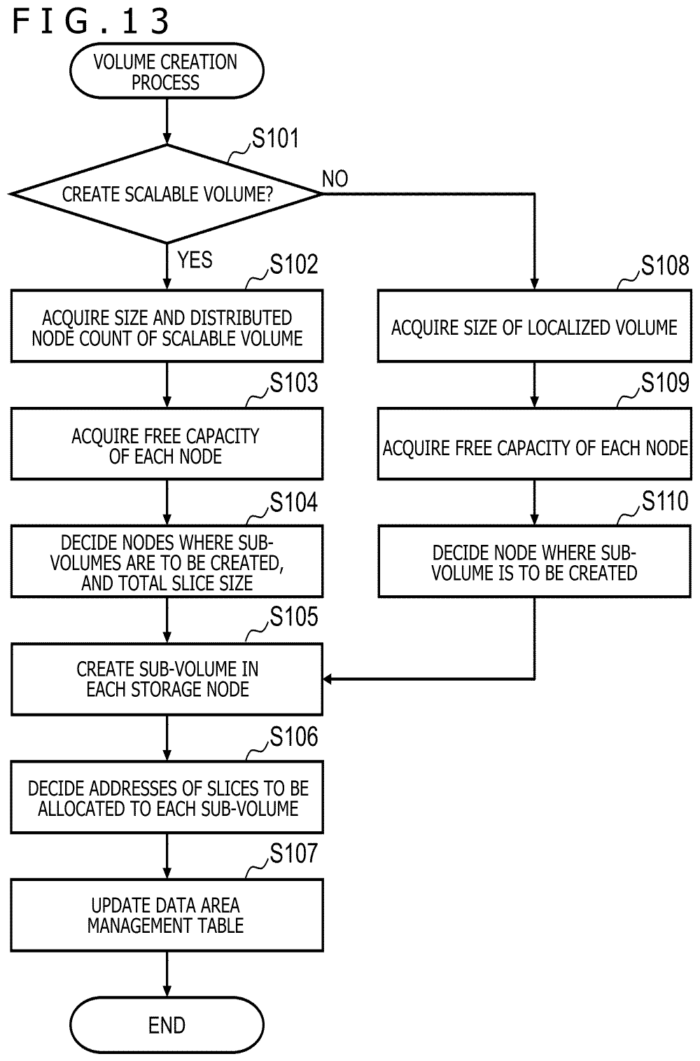

FIG. 13 is a flowchart depicting a process procedure example of the volume creation process. The volume creation process is one of processes executed by the volume management program 220.

By operation on a management console which is not depicted or the like, for example, a user (a manager of the distributed storage system 1) can transmit a command to the distributed storage system 1 via data transfer protocols such as Hypertext Transfer Protocol (HTTP), and give an instruction for creation of a volume 100. At this time, at the distributed storage system 1 having received the command, a control section (not depicted) of a node specified on the management console (or a storage node 10 having the role of a master node) interprets the command which is an instruction according to HTTP or the like, and calls the volume creation process to be performed by the volume management program 220.

According to FIG. 13, first, the volume management program 220 assesses whether or not the attribute of the volume 100 which the user has specified for creation is a scalable volume (Step S101). In a case where creation of a scalable volume is specified (YES in Step S101), the procedure proceeds to Step S102, and in a case where creation of a scalable volume is not specified, that is, creation of a localized volume is specified (NO in Step S101), the procedure proceeds to Step S108.

In Step S102, in reference to the interpreted content of the command, the volume management program 220 acquires the size and distributed node count of the scalable volume to be created. It should be noted that the distributed node count may be specified by the command in one possible scheme or may be decided uniquely in accordance with policies of a cluster in another possible scheme. In the latter scheme, for example, the distributed node count can uniquely be decided in reference to the number of nodes belonging to the cluster, the maximum number of host paths that can be defined between a host computer 30 and storage nodes 10, and the like.

Next, the volume management program 220 refers to the node pool management table 410, and acquires the free capacity of a node pool belonging to the storage nodes 10 (Step S103).

Then, the volume management program 220 decides nodes (storage nodes 10) where sub-volumes 110 are to be created, and the total size of slices to be allocated to the nodes (Step S104).

Here, a supplementary explanation of the process in Step S104 is given.

As mentioned before with reference to FIG. 3, the total size (total slice size) of slices 120 allocated to sub-volumes 110 means the effective capacities of the sub-volumes 110. In view of this, in Step S104, the volume management program 220 decides the total size of slices to be allocated to each storage node 10 such that slices 120 are allocated as evenly as possible in order to eliminate imbalances between the storage nodes 10 in the formation of the volume 100. Specifically, for example, in a case where a scalable volume having a size which is 80 TB and a distributed node count which is eight is to be created, it is desirable that the total size of slices to be allocated to each node be 10 TB.

After the desirable total slice size is decided as mentioned before, next, the volume management program 220 decides storage nodes 10 where sub-volumes 110 are to be created. When the specific example mentioned before is used, in reference to the free capacities of node pools acquired in Step S103, the volume management program 220 selects, in a prioritized manner, storage nodes 10 having free capacities which are equal to or larger than 10 TB as nodes where sub-volumes 110 are to be created.

It should be noted that, in a case where the free capacities of some node pools are smaller than the desirable capacity (10 TB in the specific example) in deciding nodes where the sub-volumes 110 are to be created, the volume management program 220 divides and assigns the shortage of capacity between the other nodes evenly. For example, in a case where it is necessary to create a sub-volume 110 in a node having a free capacity which is only 3 TB when a scalable volume having the total size of 80 TB is to be created in eight nodes in a distributed manner as in the specific example mentioned before, 7 TB, which is the shortage, is divided and assigned evenly between other nodes, making it possible to decide seven nodes to which 11 TB is to be allocated and one node to which 3 TB is to be allocated.

Note that, whereas the total size of slices to be allocated to storage nodes 10 is decided and then storage nodes 10 where sub-volumes 110 are to be created are decided in the supplementary explanation described above, the order of execution of these processes may be reversed in Step S104. In addition, whereas dividing and assigning are performed as evenly as possible in terms of capacity in the method explained in the supplementary explanation described above, dividing and assigning may be performed evenly in terms of load or dividing and assigning may be performed evenly taking both capacity and load into consideration.

After the end of Step S104 or after the end of Step S110 mentioned later, the volume management program 220 defines a sub-volume 110 for each storage node 10 decided in Step S105 or Step S110 (Step S105). At this time, as explained with reference to FIG. 3, logical spaces are defined such that the sizes of the sub-volumes 110 become the same size as the volume 100.

Next, the volume management program 220 decides the addresses of slices 120 to be allocated to the sub-volumes 110 created in Step S105 (Step S106). It may be considered that the addresses are allocated mechanically.

The volume management program 220 updates the data area management table 420 such that the data area management table 420 reflects information regarding the volume 100, sub-volumes 110, and slices 120 decided in the processes up to Step S106 (Step S107), and ends the volume creation process.

On the other hand, in a case where creation of a localized volume is specified by the command, which is a volume creation instruction, the result of determination in Step S101 is NO, and a process in Step S108 is performed. In Step S108, in reference to the interpreted content of the command, the volume management program 220 acquires the size of the localized volume to be created. In the case of the localized volume, the distributed node count is fixed to 1.

Next, as in Step S103, the volume management program 220 refers to the node pool management table 410, and acquires the free capacity of a node pool belonging to the storage nodes 10 (Step S109).

Then, by a method similar to that for deciding nodes in Step S104, the volume management program 220 decides one node where a sub-volume 110 is to be created (Step S110). Note that, because the number of sub-volumes 110 to be created is also fixed to one when a localized volume is to be created, the process of deciding the total slice size is unnecessary.

After the process in Step S110, the procedure proceeds to Step S105, and the processes in Steps S105 to S107 mentioned above are performed. That is, the volume management program 220 creates a sub-volume 110 in the storage node 10 decided in Step S110 (Step S105), decides addresses of slices 120 to be allocated to the sub-volume 110 (Step S106), makes pieces of information reflected in the data area management table 420 (Step S107), and ends the volume creation process.

By executing the volume creation process in the manner mentioned above, the volume management program 220 can create a volume 100 while reducing imbalances between storage nodes 10, in accordance with an instruction from a user (manager), regardless of the attribute concerning a scalable volume or a localized volume.

### (3-2) Write IO Process

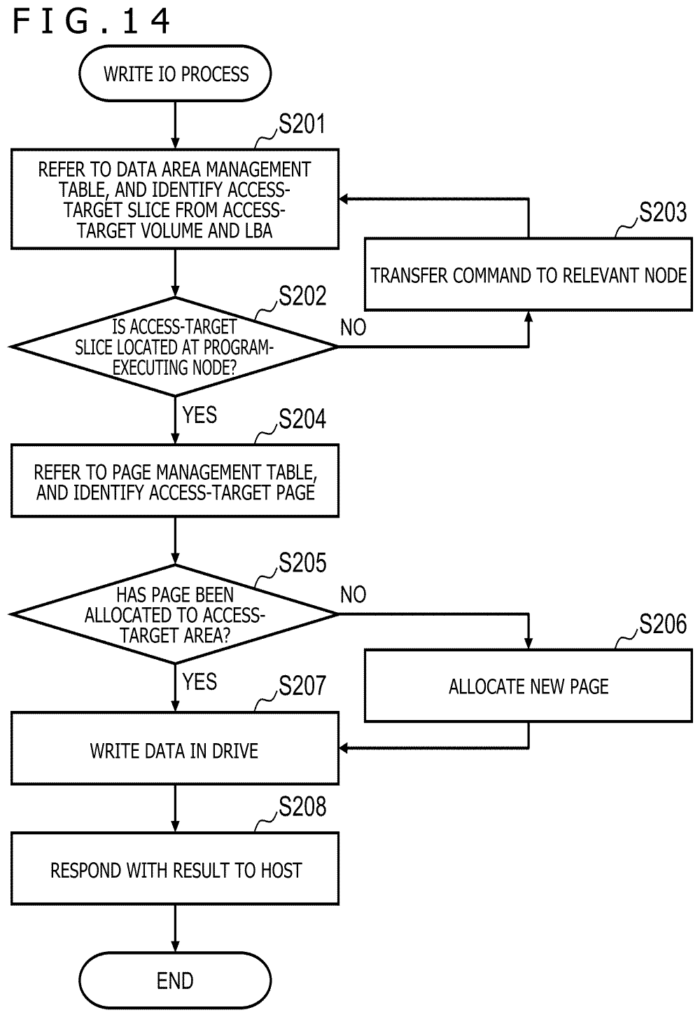

FIG. 14 is a flowchart depicting a process procedure example of the write IO process. The write IO process is one of processes executed by the read/write process program 210. The write IO process performed by the read/write process program 210 is called for processing a SCSI write command given from a host computer 30. The SCSI write command is a command given from a host computer 30 when it is attempted to write certain data at a desired address (LBA) of a volume 100, and is transmitted to a node (e.g., a storage node 10 having the role of a master node) in the distributed storage system 1.

According to FIG. 14, first, the read/write process program 210 identifies the ID and LBA of the access-target volume 100 and the access length by analyzing the received write command, and identifies the access-target volume 100 and a slice 120 relevant to the LBA by using the identified information and referring to the slice management table 423 in the data area management table 420 (Step S201). As mentioned before in the explanation of FIG. 9, in the slice management table 423, the fields of the volume IDs 4237 manage volume IDs of volumes 100 to which slices 120 belong, and the fields of the volume LBAs 4238 manage LBAs representing the positions of the slices 120 in the volumes 100 to which the slices 120 belong.

Note that, in Step S201, a plurality of slices 120 can be relevant access-target slices in some cases, depending on the access-target LBA and the access length. Even in that case, the read/write process program 210 sequentially executes processes in Step S202 and subsequent steps.

In Step S202, the read/write process program 210 refers to the sub-volume management table 422 and the slice management table 423, and assesses whether or not the access-target slice 120 identified in Step S201 is located at the program-executing node. The program-executing node means a storage node 10 having a memory 12 on which the read/write process program 210 executing the process in the step is stored. In a case where the access-target slice 120 is located at the program-executing node (YES in Step S202), the procedure proceeds to Step S204, and in a case where the access-target slice 120 is not located at the program-executing node (NO in Step S202), the procedure proceeds to Step S203.

In Step S203, the read/write process program 210 transfers the write command to a storage node 10 where the access-target slice 120 is present. Thereafter, at the storage node 10 having received the command, a write IO process to be performed by the read/write process program 210 is called, and the process is executed starting from Step S201 according to the flowchart in FIG. 14.

In Step S204, the read/write process program 210 refers to the page management table 424 stored on the program-executing node, and identifies a page 130 corresponding to the access-target slice 120.

Next, in identifying the page 130 in Step S204, the read/write process program 210 assesses whether or not a page 130 has already been allocated to an access-target data area (Step S205). In a case where a page 130 has been allocated to the access-target data area (YES in Step S205), the procedure proceeds to Step S207, and in a case where a page 130 has not been allocated to the access-target data area (NO in Step S205), the procedure proceeds to Step S206.

In Step S206, the read/write process program 210 newly allocates a page 130 to the access-target data area. As mentioned before, the technology of thin provisioning can be used for the allocation of a page 130, and, in a case where writing is performed for a data area for the first time, a physical data area (page 130) is allocated dynamically to a logical data area (slice 120). That is, the read/write process program 210 allocates a physical address of a drive 15 to a logical address space located at the access-target slice 120. Thereafter, the procedure proceeds to Step S207.

In Step S207, the read/write process program 210 writes data given from the write command, in the access-target data area (i.e., the page 130) in the drive 15.

The read/write process program 210 confirms the completion of writing of the data in the drive 15 in Step S207, then executes a process of responding with a write result to the host computer 30 (Step S208), and ends the write IO process.

Note that, in a case where the write command is transferred from a different storage node 10 as a result of the process in Step S203, processes in FIG. 14 are executed at a transfer-destination storage node 10, and the procedure reaches Step S208, the read/write process program 210 at the transfer destination transmits a response of a write result to the transfer-source storage node 10, and returns a response to the host computer 30 through the transfer-source storage node 10.

By executing the write IO process in the manner mentioned above, the read/write process program 210 of the storage node 10 having the access-target slice 120 can write data in the drive 15 of the program-executing node (specifically, the page 130 allocated corresponding to the access-target slice 120) in accordance with the write command.

### (3-3) Read IO Process

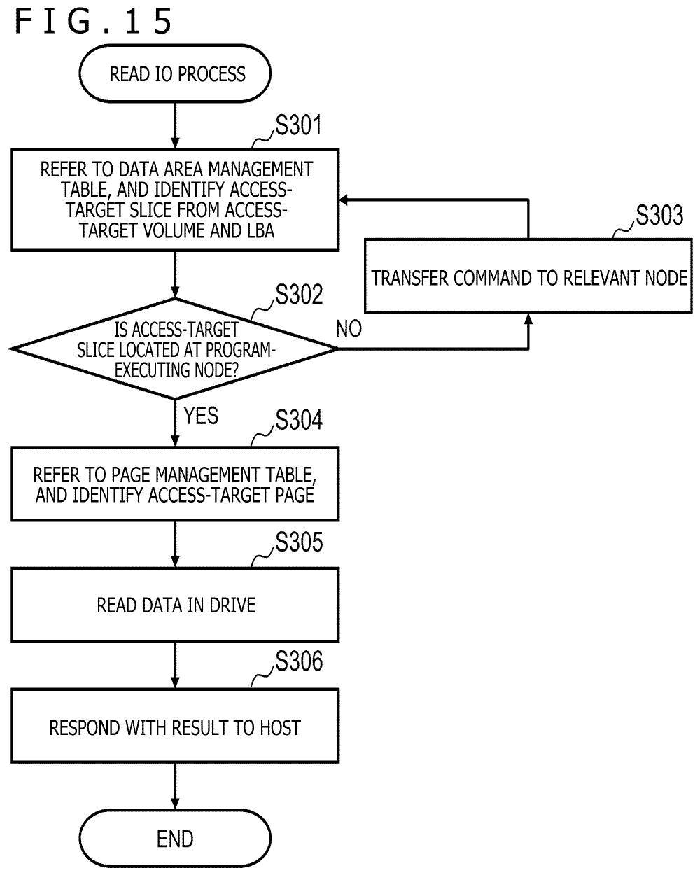

FIG. 15 is a flowchart depicting a process procedure example of the read IO process. The read IO process is one of processes executed by the read/write process program 210. The read IO process performed by the read/write process program 210 is called for processing a SCSI read command given from a host computer 30. The SCSI read command is a command given from a host computer 30 when it is attempted to read out desired data stored at a certain address (LBA) of a volume 100, and is transmitted to a node (e.g., a storage node 10 having the role of a master node) in the distributed storage system 1.

According to FIG. 15, first, the read/write process program 210 performs processes similar to Steps S201 to S204 in the write IO process depicted in FIG. 14 (Steps S301 to S304).

That is, in Step S301, the read/write process program 210 analyzes the received read command, identifies the ID and LBA of the access-target volume 100 and the access length, and identifies the relevant access-target slice 120 by using the identified information. In Step S302, the read/write process program 210 assesses whether or not the access-target slice 120 is located at the program-executing node. In a case where the access-target slice 120 is not located at the program-executing node, in Step S303, the read command is transferred to a relevant node, a read IO process is called at the transfer-destination node, and the following processes are performed. On the other hand, in a case where the access-target slice 120 is located at the program-executing node, the page management table 424 is referred to, and a page 130 corresponding to the access-target slice 120 is identified (Step S304).

After the process in Step S304, the read/write process program 210 accesses the page 130 identified in Step S304, and reads out data stored in an access-target data area from the drive 15 (Step S305). Note that, although omitted in the figure, in a case where a page 130 has not been allocated to the access-target data area, the read/write process program 210 responds with data “0,” as a read result.

The read/write process program 210 confirms the completion of reading of the data from the drive 15 in Step S305, then executes a process of responding with a read result to the host computer 30 (Step S306), and ends the read IO process.

Note that, in a case where the read command is transferred from a different storage node 10 as a result of the process in Step S303, processes in FIG. 15 are executed at a transfer-destination storage node 10, and the procedure reaches Step S306, the read/write process program 210 at the transfer destination transmits a response of a read result to the transfer-source storage node 10, and returns a response to the host computer 30 through the transfer-source storage node 10.

By executing the read IO process in the manner mentioned above, the read/write process program 210 of the storage node 10 having the access-target slice 120 can read out data from the drive 15 of the program-executing node (specifically, the page 130 corresponding to the access-target slice 120) in accordance with the read command, and respond with the data.

### (3-4) Rebalancing Process

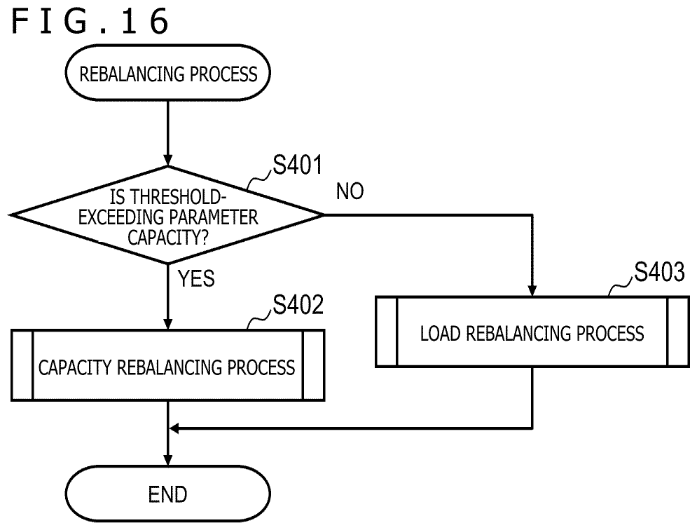

FIG. 16 is a flowchart depicting a process procedure example of the rebalancing process. The rebalancing process is one of processes executed by the rebalancing process program 240. When it is detected that a load or capacity has exceeded a predetermined threshold at any of storage nodes 10, the rebalancing process to be performed by the rebalancing process program 240 is called.

In the distributed storage system 1, for example, the rebalancing process program 240 of a master node causes the rebalancing process program 240 of each node to periodically check whether a parameter has exceeded a threshold. In a case where it is detected that a parameter has exceeded a threshold at any of the nodes, the rebalancing process program 240 of the master node takes the initiative in processes in FIG. 16.

In Step S401 in FIG. 16, the rebalancing process program 240 refers to the node pool management table 410 and the HW monitor information management table 440, and assesses whether or not a parameter that has exceeded a threshold is a capacity (Step S401). That is, the rebalancing process program 240 can determine that a capacity has exceeded a threshold in a case where a parameter in the node pool management table 410 has exceeded a threshold, and can determine that a load has exceeded a threshold in a case where any of resources in the HW monitor information management table 440 has exceeded a threshold.

In a case where it is assessed that a capacity has exceeded a threshold (YES in Step S401), the rebalancing process program 240 calls and executes a “capacity rebalancing process” of redistributing data of a volume 100 between nodes in terms of capacity (Step S402), and ends the rebalancing process after the completion. On the other hand, in a case where it is assessed that a load has exceeded a threshold (NO in Step S401), the rebalancing process program 240 calls and executes a “load rebalancing process” of redistributing data of a volume 100 between nodes in terms of load (Step S403), and ends the rebalancing process after the completion.

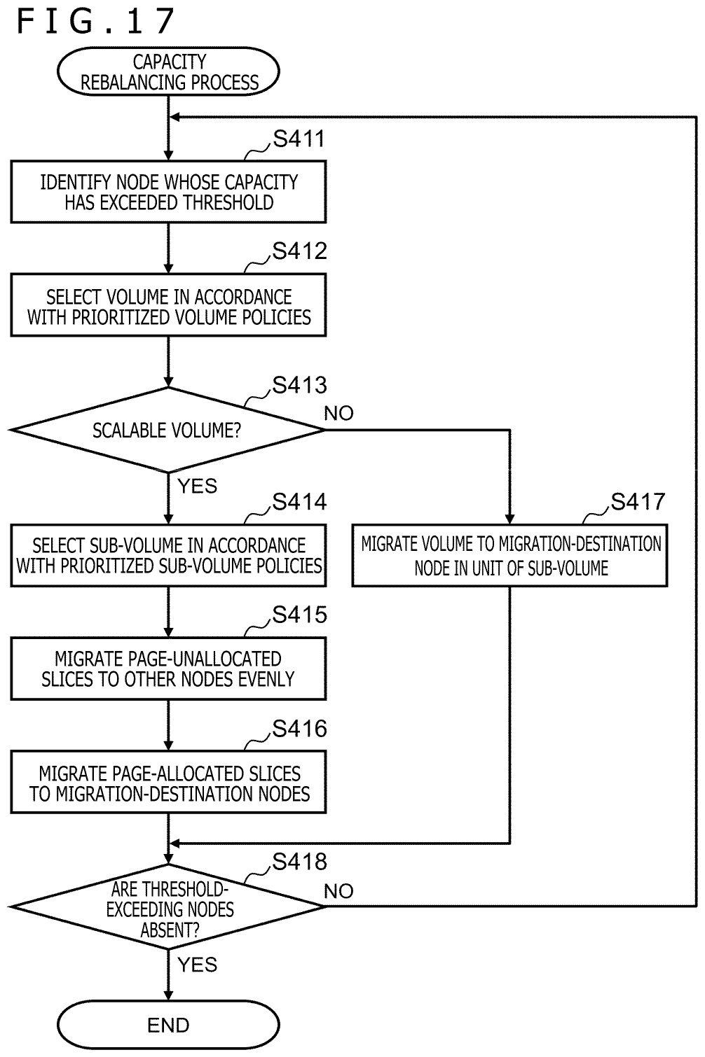

FIG. 17 is a flowchart depicting a process procedure example of the capacity rebalancing process. The capacity rebalancing process is a process equivalent to Step S402 in FIG. 16, and is one of processes executed by the rebalancing process program 240. As mentioned before, the capacity rebalancing process is called by the rebalancing process in a case where a parameter of a capacity has exceeded a threshold.

According to FIG. 17, first, the rebalancing process program 240 identifies the storage node 10 whose capacity has exceeded a capacity threshold (Step S411). Specifically, in Step S411, the rebalancing process program 240 refers to the node pool management table 410, and computes the capacity usage of each pool node by dividing a value in a field of the used capacities 4104 by a value in a field of the overall capacities 4103. The ID (a field of the node pool IDs 4101) of a node pool whose computed capacity usage has exceeded a threshold is identified, and a value (node ID) in a field of the node IDs 4102 of a relevant record is checked to thereby identify the storage node 10 whose capacity has exceeded the capacity threshold.

Next, from volumes 100 belonging to the storage node 10 identified in Step S411, the rebalancing process program 240 selects one volume 100 according to settings of “Prioritized Volume Policies” in the rebalancing policy management table 320 (Step S412).

Then, the rebalancing process program 240 assesses whether or not the volume 100 selected in Step S412 is a scalable volume (Step S413). In a case where the volume 100 is a scalable volume (YES in Step S413), the procedure proceeds to Step S414, and in a case where the volume 100 is not a scalable volume, that is, the volume 100 is a localized volume (NO in Step S413), the procedure proceeds to Step S417.

In Step S414, which is executed in a case where the volume 100 selected in Step S412 is a scalable volume, from sub-volumes 110 belonging to the volume 100 selected in Step S412, the rebalancing process program 240 selects one sub-volume 110 according to settings of “Prioritized Sub-Volume Policies (Capacity)” in the rebalancing policy management table 320.

Next, the rebalancing process program 240 migrates, to another node (storage node 10), slices 120 which are among the slices 120 allocated to the sub-volume 110 selected in Step S414 and to which pages 130 have not been allocated (Step S415). In Step S415, the slices 120 to which pages 130 have not been allocated can be assessed in reference to the fields of the page-allocated size 4233 in the slice management table 423, and the rebalancing process program 240 performs migration of all the relevant slices 120 such that the number of slices 120 in other storage nodes 10 sharing the selected volume 100 becomes as even as possible.

Here, the reason why the process described above is performed in Step S415 is explained in detail. Because data has not yet been stored in an area managed by a slice 120 to which a page 130 has not been allocated, data transfer is unnecessary, and it is sufficient if only control information related to allocation of the slice 120 is updated (rewritten), when the slice 120 is to be migrated to another storage node 10. Accordingly, the overhead of the migration of the slice 120 is small. Additionally, by migrating a slice 120 to which a page 130 has not been allocated to another storage node 10 in advance, it is possible to reduce the probability that a new write is performed in the future on the storage node 10 whose capacity has exceeded a threshold.

After the process in Step S415, the rebalancing process program 240 migrates a slice 120 selected in accordance with “Slice Selection Policies” in the rebalancing policy management table 320 from slices 120 which belong to the sub-volume 110 selected in Step S414 and to which pages 130 have been allocated, to a storage node 10 (migration-destination node) selected according to settings of “Migration-Destination Node Selection Policies” in the rebalancing policy management table 320 (Step S416).

Due to the process in Step S416, at least part of data allocated to the slice 120 is migrated to another storage node 10; as a result, the used capacity of the node pool at the migration-source storage node 10 can be reduced. Note that the process in Step S416 is executed repeatedly until the used capacity of the node pool at the migration-source storage node 10 (i.e., the storage node 10 selected in Step S411) falls below the threshold, and the procedure proceeds to Step S418 after the completion.

On the other hand, in a case where the volume 100 selected in Step S412 is a localized volume, slices 120 belonging to the volume 100 are mapped to one sub-volume 110, and hence, the arrangement of slices 120 cannot be changed between nodes.

In view of this, in Step S417, in which migration is performed after the result of assessment in Step S413 is NO, the rebalancing process program 240 migrates sub-volumes 110 and the volume 100 to a migration-destination node in units of sub-volumes 110.

Specifically, in Step S417, from sub-volumes 110 belonging to the volume 100 selected in Step S412 and according to settings of “Prioritized Sub-Volume Policies” in the rebalancing policy management table 320, the rebalancing process program 240 selects sub-volumes 110 to be migrated, and migrates the sub-volumes 110 to storage nodes 10 (migration-destination nodes) selected according to settings of “Migration-Destination Node Selection Policies” in the rebalancing policy management table 320. After the completion of Step S417, the procedure proceeds to Step S418.

In Step S418, the rebalancing process program 240 assesses whether other storage nodes 10 whose capacities have exceeded the threshold are absent, and ends the capacity rebalancing process in a case where other relevant storage nodes 10 are absent (YES in Step S418).

On the other hand, in a case where other storage nodes 10 whose capacities have exceeded the threshold are present in Step S418 (NO in Step S418), the procedure returns to Step S411, and the rebalancing process program 240 repeats the processes mentioned above. It should be noted that, in this repetitive process, sub-volumes 110 and volumes 100 already having no to-be-migrated slices 120 are excluded from candidates of selection according to the rebalancing policies, and sub-volumes 110 and volumes 100 that are prioritized next in accordance with the rebalancing policies are selected.

By executing the capacity rebalancing process in the manner mentioned above, the rebalancing process program 240 can migrate data in a node whose capacity has exceeded a threshold to another node, and can solve the problem of the capacity exceeding the capacity threshold.

Note that, whereas “1. Prioritize High-Load Slice” and “2. Prioritize Low-Load Slice” are prepared as settings of “Slice Selection Policies” in the rebalancing policy management table 320 depicted in FIG. 6, settings to be used may be decided as desired depending on what is specified by a user or selected by the system. Specifically, in a typical capacity rebalancing process, “2. Prioritize Low-Load Slice” is used as settings preferably. It should be noted that, in a case where the capacity rebalancing process and the load rebalancing process mentioned later are executed in combination in the rebalancing process, “1. Prioritize High-Load Slice” is used as settings preferably in some cases.

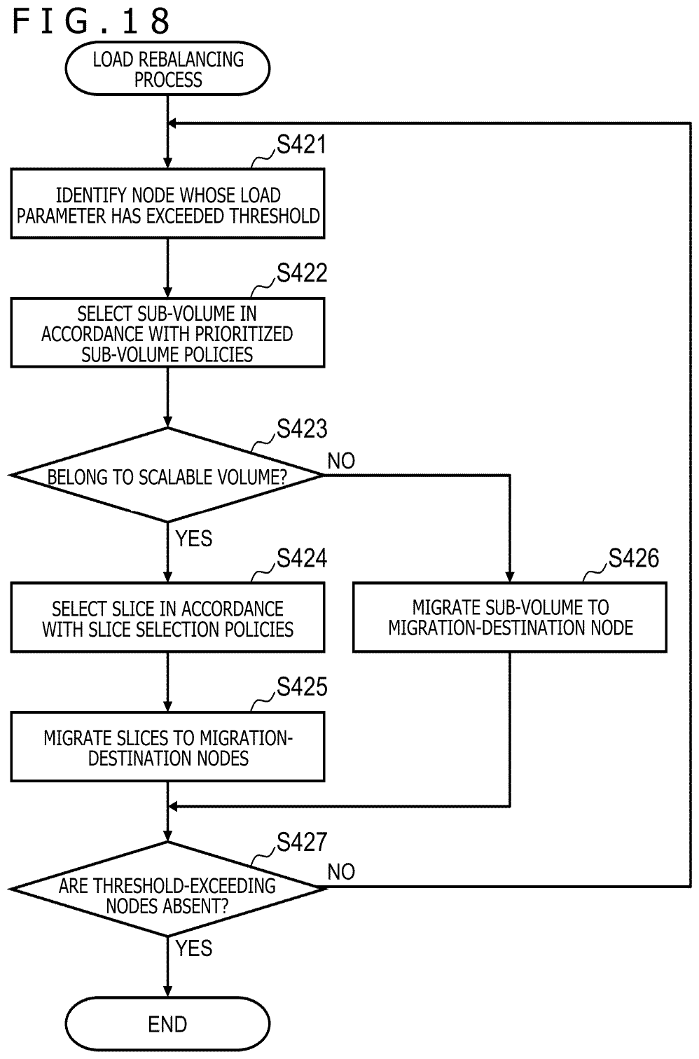

FIG. 18 is a flowchart depicting a process procedure example of the load rebalancing process. The load rebalancing process is a process equivalent to Step S403 in FIG. 16, and is one of processes executed by the rebalancing process program 240. As mentioned before, the load rebalancing process is called by the rebalancing process in a case where a parameter of a load has exceeded a threshold.

According to FIG. 18, first, the rebalancing process program 240 identifies a storage node 10 whose load has exceeded a load threshold (Step S421). Specifically, in Step S421, the rebalancing process program 240 refers to each table included in the HW monitor information management table 440 at each storage node 10, and identifies a storage node 10 and HW whose load has exceeded a threshold.

Next, from sub-volumes 110 of a volume 100 belonging to the storage node 10 identified in Step S421, the rebalancing process program 240 selects one sub-volume 110 according to settings of “Prioritized Sub-Volume Policies (Load)” in the rebalancing policy management table 320 (Step S422).

Note that, whereas it is necessary to determine the load status of each sub-volume when a sub-volume 110 is selected according to settings of “Prioritized Sub-Volume Policies (Load),” this is possible by referring to the sub-volume monitor information management table 451. Specifically, for example, in a case where the settings content of “Prioritized Sub-Volume Policies (Load)” is “1. Prioritize High-Load Sub-Volume,” it is sufficient if information regarding each sub-volume 110 managed by the sub-volume monitor information management table 451 is referred to and a sub-volume 110 having the highest load is selected.

Next, the rebalancing process program 240 assesses whether or not the volume 100 to which the sub-volume 110 selected in Step S422 belongs is a scalable volume (Step S423). In a case where the volume 100 is a scalable volume (YES in Step S423), the procedure proceeds to Step S424, and in a case where the volume 100 is not a scalable volume, that is, the volume 100 is a localized volume (NO in Step S423), the procedure proceeds to Step S426.

In Step S424, which is executed in a case where the volume 100 to which the sub-volume 110 selected in Step S422 belongs is a scalable volume, from slices 120 belonging to the sub-volume 110 described above, the rebalancing process program 240 selects a slice 120 according to settings of “Slice Selection Policies” in the rebalancing policy management table 320.

Note that, whereas it is necessary to determine the load status of each slice when a slice 120 is selected according to settings of “Slice Selection Policies,” this is possible by referring to the slice monitor information management table 452. Specifically, for example, in a case where the settings content of “Slice Selection Policies” is “1. Prioritize High-Load Slice,” it is sufficient if information regarding each slice 120 managed by the slice monitor information management table 452 is referred to and a slice 120 having the highest load is selected.

Next, the rebalancing process program 240 migrates the slice 120 selected in Step S424 to a migration-destination node (Step S425). At this time, the migration-destination storage node 10 is selected according to settings of “Migration-Destination Node Selection Policies” in the rebalancing policy management table 320. Specifically, for example, in a case where the settings content of “Migration-Destination Node Selection Policies” is “1. Prioritize Node Having Lowest Threshold-Exceeding Parameter” and the load of the CPU 11 managed by the CPU monitor information management table 441 at the storage node 10 identified in Step S421 has exceeded a threshold, a storage node 10 whose load of the CPU 11 is the lowest among other storage nodes 10 is selected as the migration-destination node. After the process in Step S425, the procedure proceeds to Step S427.

On the other hand, in Step S426 which is executed in a case where the volume 100 to which the sub-volume 110 selected in Step S422 belongs is a localized volume, the rebalancing process program 240 migrates the sub-volume 110 described above and the volume 100 described above to a migration-destination node. At this time, as in Step S425, the migration-destination storage node 10 is selected according to settings of “Migration-Destination Node Selection Policies” in the rebalancing policy management table 320. After the process in Step S426, the procedure proceeds to Step S427.

In Step S427, the rebalancing process program 240 assesses whether other storage nodes 10 whose loads have exceeded the threshold are absent, and ends the load rebalancing process in a case where other relevant storage nodes 10 are absent (YES in Step S427).

On the other hand, in a case where other storage nodes 10 whose loads have exceeded the threshold are present in Step S427 (NO in Step S427), the procedure returns to Step S421, and the rebalancing process program 240 repeats the processes mentioned above. It should be noted that, in this repetitive process, sub-volumes 110 and volumes 100 already having no to-be-migrated slices 120 are excluded from candidates of selection according to the rebalancing policies, and sub-volumes 110 and volumes 100 that are prioritized next in accordance with the rebalancing policies are selected.

By executing the load rebalancing process in the manner mentioned above, the rebalancing process program 240 can migrate data in a node whose load has exceeded a threshold to another node, and can solve the problem of the load exceeding the load threshold.

Note that whereas “1. Prioritize High-Load Slice” and “2. Prioritize Low-Load Slice” are prepared as settings of “Slice Selection Policies” in the rebalancing policy management table 320 depicted in FIG. 6, settings to be used may be decided as desired depending on what is specified by a user or selected by the system.

Specifically, because a high-load slice 120 can be prioritized in migration to another node in the load rebalancing process in a case where “1. Prioritize High-Load Slice” is set, a threshold-exceeding state can be eliminated by early distribution, although the migration requires costs (a load on the system performance). On the other hand, because a low-load slice 120 can be prioritized for migration to another node in the load rebalancing process in a case where “2. Prioritize Low-Load Slice” is set, an advantage of reducing deteriorations of the system performance at the time of the migration can be expected, although it takes a longer migration time for the overall rebalancing. That is, there is a trade-off relation between the advantages of the two types of settings described above in “Slice Selection Policies,” and preferably the two types of settings are selected according to system operation styles or user demands.

### (3-5) Node Adding/Removing Process

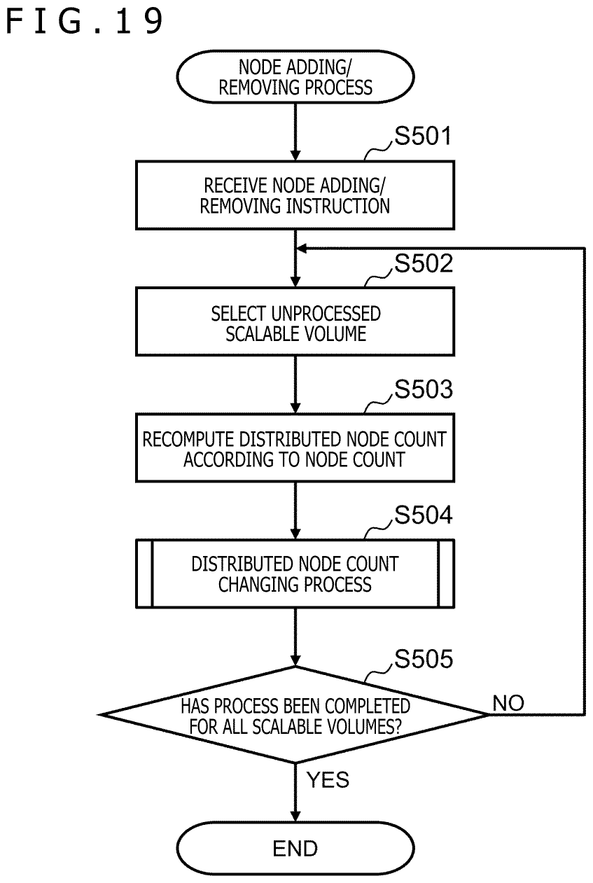

FIG. 19 is a flowchart depicting a process procedure example of the node adding/removing process. The node adding/removing process is a process of adding a node to a cluster or removing a node from a cluster, and is one of processes executed by the cluster management program 230.

In the node adding/removing process, the cluster management program 230 recomputes the distributed node count of a scalable volume in association with addition or removal of a node (storage node 10), and, in a case where the distributed node count has changed, changes allocation of slices of the scalable volume according to the distributed node count obtained after the change.

According to FIG. 19, first, a storage node 10 receives an adding/removing instruction for adding or removing a node (Step S501). The node adding/removing instruction may be received by any of nodes of the cluster, and the node having received the instruction transfers the received instruction to a configuration management master node executing the cluster management program 230.

Next, the cluster management program 230 of the master node selects one of scalable volumes on which processes of a distributed node count changing process in Step S504 mentioned later have not been performed (Step S502). The following processes in Step S503 and Step S504 are processes to be performed on the scalable volume selected in Step S502.

Next, the cluster management program 230 recomputes the distributed node count of the scalable volume according to the number of nodes included in the cluster in the distributed storage system 1 (Step S503). Specifically, for example, the cluster management program 230 sets the maximum value of the distributed node count for the volume 100 in advance, and, in a case where a node is added, decides the distributed node count such that the value of the distributed node count becomes the same as the number of nodes included in the cluster until the distributed node count of the volume 100 reaches the maximum value. In addition, in a case where a node is removed, the distributed node count is decided such that the value of the distributed node count becomes the same as the node count obtained after the removal.

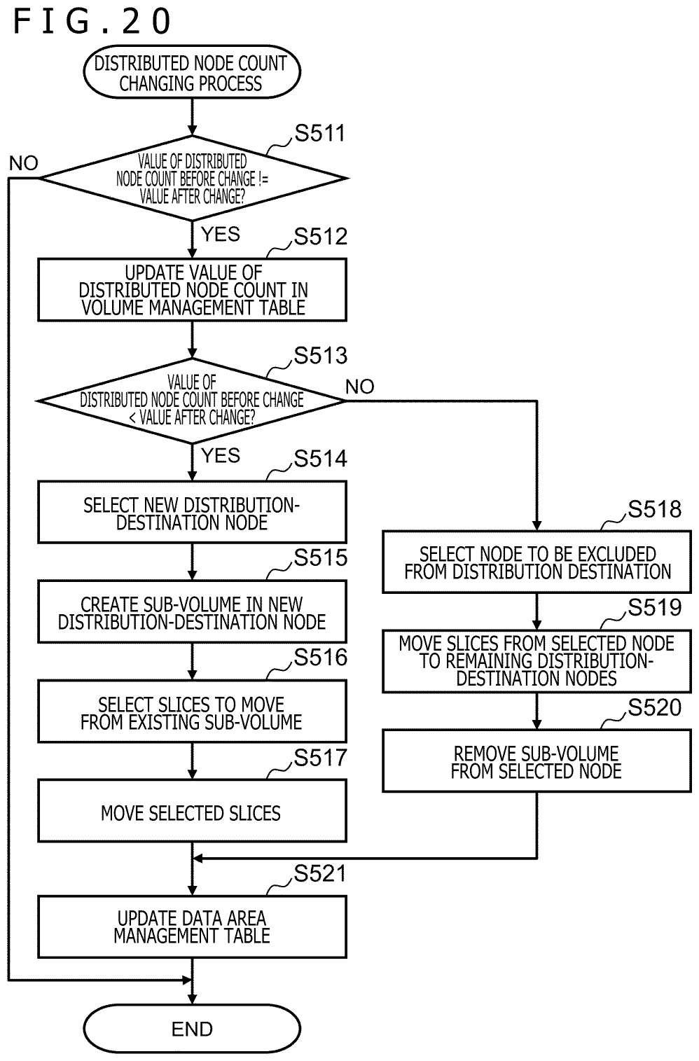

Next, in a case where the distributed node count recomputed in Step S503 for the scalable volume selected in Step S502 is different from the distributed node count before the recomputation, the cluster management program 230 changes allocation of slices 120 of the scalable volume according to the recomputed distributed node count (Step S504). The process in Step S504 is referred to as a “distributed node count changing process” below, and details of the process procedure are mentioned later with reference to FIG. 20.

After the process in Step S504, the cluster management program 230 assesses whether or not the distributed node count changing process has been completed for all scalable volumes in the cluster (Step S505). In a case where unprocessed scalable volumes are present (NO in Step S305), the procedure returns to Step S502, and the process is repeated. On the other hand, in a case where unprocessed scalable volumes are absent (YES in Step S305), the node adding/removing process is ended.

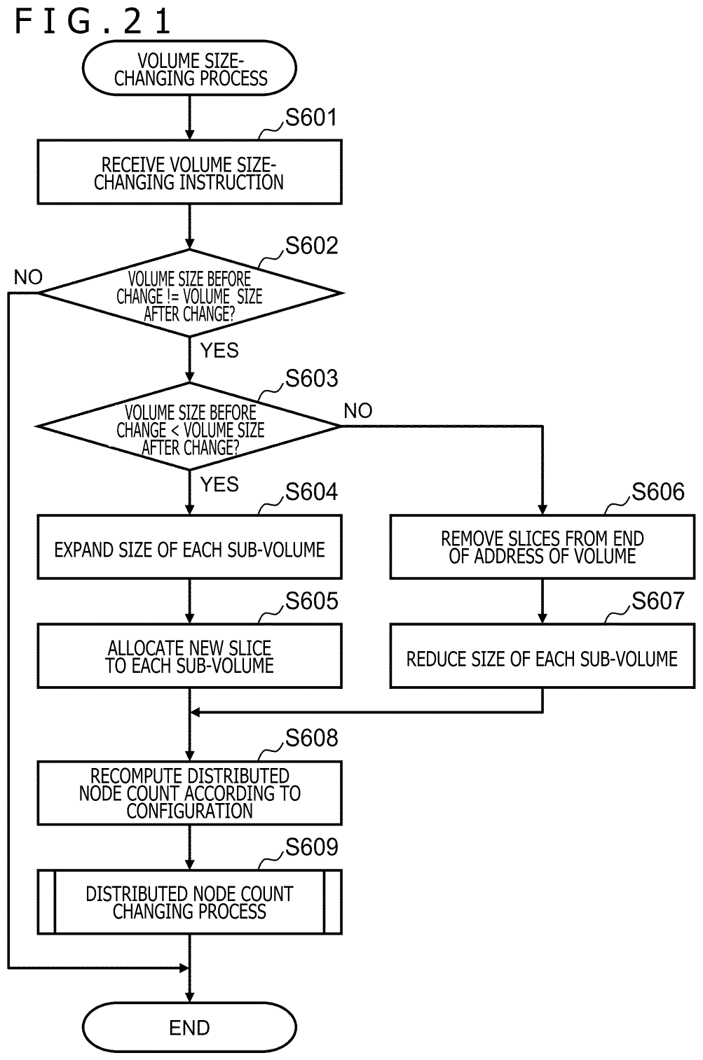

FIG. 20 is a flowchart depicting a process procedure example of the distributed node count changing process. As mentioned before, the distributed node count changing process depicted in FIG. 20 is equivalent to the process in Step S504 in FIG. 19, and executed by the cluster management program 230. Note that the distributed node count changing process depicted in FIG. 20 is also called and executed in the volume size-changing process in FIG. 21 mentioned later.

As depicted in FIG. 20, first, the cluster management program 230 compares the distributed node count recomputed in Step S503 in FIG. 19 and the distributed node count used before the recomputation, and assesses whether or not the distributed node counts are different values (Step S511).

Note that, whereas the recomputed distributed node count has not been updated as a new distributed node count at the time point of Step S511, the recomputed distributed node count is denoted as the distributed node count “after the change,” and the distributed node count used before the recomputation is denoted as the distributed node count “before the change” in some cases in FIG. 20 and an explanation thereof for convenience of explanation. That is, in Step S511, the cluster management program 230 assesses whether or not the distributed node counts before the change and after the change are different values.

In a case where the distributed node count after the change and the distributed node count before the change are different values in Step S511 (YES in Step S511), the procedure proceeds to Step S512. On the other hand, in a case where the distributed node count after the change and the distributed node count before the change are the same value, that is, the distributed node count has not changed as a result of the recomputation (NO in Step S511), it is not necessary to change allocation of the slices 120, and hence, the distributed node count changing process is ended.

In Step S512, for the scalable volume which is currently being processed (the scalable volume selected in Step S502 in FIG. 19), the cluster management program 230 updates the value of a field of the distributed node counts 4214 in the volume management table 421 by using the distributed node count recomputed in Step S503 in FIG. 19.

Next, the cluster management program 230 assesses whether or not the distributed node count after the change is larger than the distributed node count before the change (Step S513).

In a case where the distributed node count after the change is larger than the distributed node count before the change in Step S513 (YES in Step S513), the cluster management program 230 performs the following processes in Steps S514 to S517 to thereby move some of the slices 120 of the scalable volume being processed to a new distribution-destination node, and scale out the volume 100.

First, in Step S514, the cluster management program 230 selects a node to be a new distribution destination, in order to scale out the distribution of the volume area. The new-distribution-destination node is selected taking the free capacity and load status of each node into consideration. For example, a node having a large free capacity and additionally having a low load is selected.

Next, in Step S515, the cluster management program 230 creates a sub-volume 110 in the new distribution-destination node selected in Step S514.

Then, in Step S516, from existing sub-volumes 110, the cluster management program 230 selects slices 120 to be moved to the sub-volume 110 created in Step S515. The slices 120 to be moved to the new sub-volume 110 are preferably selected from each existing sub-volume 110 such that the number of slices 120 becomes even numbers.

In Step S517, the cluster management program 230 can scale out the volume 100 by moving the slices 120 selected in Step S516 from the existing sub-volumes 110 to the sub-volume 110 created in Step S515.

On the other hand, in a case where the distributed node count after the change is equal to or smaller than the distributed node count before the change in Step S513 (NO in Step S513), the cluster management program 230 performs the following processes in Steps S518 to S520 to thereby select one sub-volume 110 from sub-volumes 110 belonging to the scalable volume being processed, move all slices 120 of the sub-volume 110 to the existing distribution-destination nodes, and scale in the volume 100.

First, in Step S518, the cluster management program 230 selects a node (to-be-excluded node) to be excluded from the distribution destination of the sub-volume 110, in order to scale in the distribution of the volume area. The to-be-excluded node is selected taking the free capacity and load status of each node into consideration. For example, a node having a small free capacity and additionally having a high load is selected.

Next, in Step S519, the cluster management program 230 moves slices 120 from the sub-volume 110 of the to-be-excluded node selected in Step S518 to the remaining distribution-destination nodes. At this time, the cluster management program 230 preferably selects movement destinations of the slices 120 such that, after the movement, the number of slices 120 allocated to sub-volumes 110 of the remaining distribution-destination nodes becomes an even number.

In Step S520, the cluster management program 230 can scale in the volume 100 by removing the sub-volume 110 in the to-be-excluded node selected in Step S518.

Finally, after the completion of Step S517 or Step S520 described above, the cluster management program 230 updates the tables included in the data area management table 420 such that information regarding the volume 100, the sub-volumes 110, and the slices 120 that have been changed in the process of scaling out (Steps S514 to S517) or scaling in (Steps S518 to S520) are reflected in the tables (Step S521), and ends the distributed node count changing process.

By executing the processes depicted in FIG. 19 and FIG. 20 thus far, the cluster management program 230 can scale out or scale in a volume 100 flexibly according to the number of installed computer nodes, while the number of sub-volumes 110 in each computer node is fixed to one at the time of addition or removal of a computer node (storage node 10) in the distributed storage system 1.

### (3-6) Volume Size-Changing Process

FIG. 21 is a flowchart depicting a process procedure example of the volume size-changing process. The volume size-changing process is a process of changing (expanding or reducing) the size of a specified volume 100, and is executed mainly by the volume management program 220. Note that a process in Step S609 is executed by the cluster management program 230.

In the volume size-changing process, the volume management program 220 recomputes the distributed node count of a scalable volume in association with a size-change of the volume 100, and, in a case where the distributed node count has changed, changes allocation of slices 120 of the scalable volume according to the recomputed distributed node count.

According to FIG. 21, first, the volume management program 220 receives a size-changing instruction for the volume 100. The size-changing instruction for the volume 100 may be received at any of nodes of a cluster, and the node having received the instruction transfers the received instruction to a configuration management master node executing the volume management program 220.

Next, the volume management program 220 of the master node assesses whether or not the volume size after the change has changed from the volume size before the change in the size-changing instruction received in Step S601 (Step S602). In a case where the volume size has not changed (NO in Step S602), a special process is not necessary, and hence, the volume size-changing process is ended. In a case where the volume size has changed (YES in Step S602), the procedure proceeds to Step S603.

In Step S603, the volume management program 220 assesses whether or not the volume size after the change is larger than the volume size before the change, in the size-changing instruction. In a case where the volume size is to be increased (YES in Step S603), processes in Steps S604 and S605 are performed to thereby expand the volume size. On the other hand, in a case where the volume size is to be reduced (NO in Step S603), processes in Steps S606 and S607 are performed to thereby reduce the volume size.

In Step S604, the volume management program 220 expands the size of each sub-volume 110 of the scalable volume treated as the size-changing-instruction target. At this time, for example, the expansion is performed such that the total size of the sub-volumes 110 becomes the same size as the scalable volume obtained after the expansion.

In the next Step S605, to the sub-volumes 110 whose sizes have been expanded in Step S604, the volume management program 220 allocates new slice 120 in amounts corresponding to expanded sizes. In Step S605, the volume management program 220 decides the number of slices 120 to be allocated, such that even number of slices 120 are allocated to the sub-volumes 110, for example. Specifically, the number of slices 120 to be allocated can be calculated by dividing the expanded size of the scalable volume by the distributed node count. After the process in Step S605, the procedure proceeds to Step S608.

In Step S606, the volume management program 220 removes slices 120 from the end of the address of the volume 100 by an amount corresponding to the reduced size.

In the next Step S607, the volume management program 220 reduces the size of each sub-volume 110 of the scalable volume treated as the size-changing-instruction target. At this time, for example, the reduction is performed such that the total size of the sub-volumes 110 becomes the same size as the scalable volume obtained after the reduction. After the process in Step S607, the procedure proceeds to Step S608.

In Step S608, the volume management program 220 recomputes the distributed node count according to the volume size after the change, for the scalable volume treated as the size-changing-instruction target. For example, in a case where the total size of slices 120 allocated to a sub-volume 110 has exceeded a capacity that can be provided to a sub-volume 110 in one node, as a result of the size expansion of the volume 100, the distributed node count is increased to thereby prevent an occurrence of depletion of capacities. In addition, for example, in a case where the total size of slices 120 removed from a sub-volume 110 has exceeded a capacity that can be provided to a sub-volume 110 in one node as a result of the size reduction of the volume 100, the distributed node count is reduced to thereby reduce excessive node distribution.

Thereafter, the volume management program 220 calls the cluster management program 230, and causes the distributed node count changing process (see FIG. 20) mentioned before to be executed, by using the distributed node count recomputed in Step S608, to thereby execute allocation of slices 120 according to the distributed node count after the recomputation (Step S609). After the completion of Step S609, the volume size-changing process is ended.

By executing the processes depicted in FIG. 21 thus far, the volume management program 220 and the cluster management program 230 can arrange slices 120 such that capacities and/or loads are distributed between nodes forming a volume 100, by performing expansion or reduction of a scalable volume (volume 100) in accordance with a size-changing instruction for the volume 100, and also recomputing the distributed node count in association with a configurational change accompanying the expansion or reduction, and moving slices 120 according to the distributed node count after the recomputation.

As explained above, the distributed storage system 1 according to the present embodiment divides the area of sub-volumes 110 included in a volume 100 into a plurality of slices 120, allocates the sub-volumes 110 to a plurality of computer nodes (storage node 10) in units of slices, monitors loads of access to the volume 100, and manages monitor information (the HW monitor information management table 440 and the data area monitor information management table 450). In addition, by setting the number of sub-volumes 110 included in the volume 100 per one computer node to one, it is possible to prevent deteriorations of the management performance of storage control software (the storage control program 200) operating on each computer node. Explaining specifically, by keeping the number of sub-volumes 110 managed by the storage control program 200 operating on each storage node 10 constant (in this case, one), it is possible to prevent deteriorations of the management performance in which control information regarding sub-volumes 110 in one computer node increases due to an increase of the number of the sub-volumes 110 and the processing amount of the storage control program 200 increases undesirably. Further, by setting the size of the sub-volumes 110 included in the volume 100 to the same size as the volume 100, a problem that it becomes difficult to flexibly migrate data between storage nodes 10 in a case where the size of a sub-volume 110 in one computer node has increased is solved, and this contributes to realization of a flexible scale-out process. In a case where access loads are low in the monitor information described above, and one computer node is sufficient to provide performance demanded by the volume 100, the distributed storage system 1 according to the present embodiment controls allocation such that slices 120 included in the volume 100 are aggregated at the one computer node (localized volume). On the other hand, in a case where access loads are high and one computer node is insufficient to provide performance demanded by the volume 100, the distributed storage system 1 according to the present embodiment performs control such that slices 120 included in the volume 100 are allocated to a plurality of computer nodes in a distributed manner (scalable volume). In addition, when a host (host computer 30) accesses data in the volume 100, by assessing to which computer node a slice 120 storing access-destination data has been allocated, imbalanced loads due to access to particular computer nodes are prevented.

By being configured in the manner described above, the distributed storage system 1 according to the present embodiment can access data in a local storage (drives 15) without fail in a case where one computer node is sufficient for an access load, and can thus respond fast to the host. In addition, in a case where one computer node is insufficient for an access load, the distributed storage system 1 according to the present embodiment processes the access by using a plurality of computer nodes, and can thereby provide a high throughput (IOPS) to the host. In addition, because these control processes are performed automatically by the distributed storage system 1 without a user being aware of those control processes, the user can enjoy the benefits described above with an operational burden similar to that caused by the storage system disclosed in Japanese Patent No. 4963892, for example.

In addition, in a case where a predetermined capacity- or load-related parameter of the volume 100 has exceeded a threshold at any of computer nodes (storage nodes 10), the distributed storage system 1 according to the present embodiment executes the rebalancing process in terms of capacity or load, and can thereby migrate volume data regarding the node whose parameter has exceeded the threshold to another node, and eliminate the state where the parameter has exceeded the threshold. That is, the response time and throughput for one volume formed in one or more nodes in a distributed manner can be changed automatically to suitable states according to access loads.

In addition, by executing the node adding/removing process when a computer node is added or removed, the distributed storage system 1 according to the present embodiment recomputes the distributed node count of the volume 100 in association with a change of the node count, and allocates slices 120 to sub-volumes 110 of distribution-destination nodes such that no imbalance occurs. Thus, the distributed storage system 1 can scale out (or scale in) the capacity and/or performance of the volume according to addition (or removal) of a computer node.

In addition, by executing the volume size-changing process when the size of the volume 100 is to be changed, the distributed storage system 1 according to the present embodiment can automatically adjust the configuration of sub-volumes 110 of the volume 100 and allocation of slices 120 according to the size to be changed. Thus, the volume 100 can be formed while the capacity and/or load is distributed between nodes suitably according to the size-change of the volume 100.

Note that the present invention is not limited to the embodiment described above, and includes various modification examples. For example, the embodiment described above is explained in detail in order to explain the present invention in an easy-to-understand manner, and is not necessarily limited to the one including all the configurations explained. In addition, some of the configurations of the embodiment can additionally have other configurations, can be removed, or can be replaced with other configurations.

In addition, each configuration, functionality, processing section, processing means, or the like described above may be partially or entirely realized with hardware by designing it with an integrated circuit (IC), and so on, for example. In addition, each configuration, functionality, or the like described above may be realized with software by a processor interpreting and executing a program to realize respective functionalities. Such information as a program, a table, or a file to realize each functionality can be placed on a memory, a hard disk, a recording apparatus such as a Solid State Drive (SSD), or a recording medium such as an IC card, a Secure Digital (SD) card, or a Digital Versatile Disc (DVD).

In addition, control lines and information lines that are considered to be necessary for explanation are depicted in the figures, but it is not necessarily always the case that all control lines and information lines of products are depicted. In practice, it may be considered that almost all configurations are connected mutually.

What is claimed is:

1. A distributed storage system comprising:
a plurality of computer nodes having processors; and
a storage drive, wherein
the distributed storage system provides a volume,
each of the plurality of computer nodes provides a sub-volume, and the processor of the computer node manages settings of each sub-volume of the computer node,
the volume is capable of being configured by using a plurality of sub-volumes provided by the plurality of computer nodes,
the sub-volumes include a plurality of logical storage areas formed by being allocated with physical storage areas of the storage drive, and
the plurality of computer nodes move the logical storage areas between the sub-volumes that belong to the same volume and that are provided by different computer nodes.

2. The distributed storage system according to claim 1, wherein the volume is allocated to one sub-volume per one computer node, and each of the sub-volume has a size sufficient for containing all logical storage areas related to the volume.

3. The distributed storage system according to claim 1, wherein, at a time of addition of a computer node to form the volume and at a time of execution of rebalancing in the volume, the processor of at least one of the plurality of computer nodes migrates logical storage areas included in the volume between the sub-volumes.

4. The distributed storage system according to claim 1, wherein, at a time of size expansion or size reduction of the volume, the processor of at least one of the plurality of computer nodes migrates logical storage areas included in the volume between the sub-volumes.

5. The distributed storage system according to claim 1, wherein at a time of creation of the volume, the processor of at least one of the plurality of computer nodes maps logical storage areas included in the volume to the sub-volumes.

6. The distributed storage system according to claim 1, wherein the volume capable of being configured in a form in which all of the logical storage areas are mapped to one sub-volume and in a form in which the logical storage areas are mapped to a plurality of the sub-volumes in a distributed manner.

7. The distributed storage system according to claim 3, wherein, when migrating the logical storage areas included in the volume between the sub-volumes, the processor of at least one of the plurality of computer nodes executes a first rebalancing process of migrating the logical storage areas in terms of data capacity or a second rebalancing process of migrating the logical storage areas in terms of data input/output process load.

8. The distributed storage system according to claim 7, wherein, in the second rebalancing process, a sub-volume of interest is selected in reference to sub-volume load information, and a logical storage area to be moved is selected in reference to load information of the logical storage area in the selected sub-volume.

9. The distributed storage system according to claim 1, wherein, in a case where a data write to a data area whose logical storage area is managed has occurred, the processor allocates, to the logical storage area, in predetermined subdivided units, the physical storage area of the storage drive in the computer node having the sub-volume to which the logical storage area is allocated.

10. The distributed storage system according to claim 7, wherein, in the first rebalancing process, the processor migrates, between the sub-volumes, a logical storage area to which a physical storage area of the storage drive has not been allocated, by updating control information regarding allocation of the logical storage areas.

11. The distributed storage system according to claim 10, wherein, in the first rebalancing process, after the logical storage area to which a physical storage area of the storage drive has not been allocated has been migrated between the sub-volumes, the processor migrates, between the sub-volumes, a logical storage area to which a physical storage area of the storage drive has been allocated.

12. A volume management method performed by a distributed storage system that has a plurality of computer nodes having processors and a storage drive and that provides a volume, wherein
each of the plurality of computer nodes provides a sub-volume, and the processor of the computer node manages settings of each sub-volume of the computer node,
the volume is capable of being configured by using a plurality of sub-volumes provided by the plurality of computer nodes,
the sub-volumes include a plurality of logical storage areas formed by being allocated with physical storage areas of the storage drive, and
the plurality of computer nodes move the logical storage areas between the sub-volumes that belong to the same volume and that are provided by different computer nodes.
